(19) United States
(12) Patent Application Publication
(10) Pub. No.: US 2007/0194942 A1
(43) Pub. Date: Aug. 23, 2007

(54) CIRCUIT PROTECTOR MONITORING ASSEMBLY, SYSTEM AND METHOD

(76) Inventor: Matthew R. Darr, Godfrey, IL (US)

Correspondence Address: John S. Beulick;Armstrong Teasdale LLP, Suite 2600, One Metropolitan Square, St. Louis, MO, 63102, US

(21) Appl. No.: 11/668,621

(22) Filed: Jan. 30, 2007

Related U.S. Application Data
(63) Continuation-in-part of application No. 11/223,385, filed on Sep. 9, 2005.
(60) Provisional application No. 60/608,580, filed on Sep. 10, 2004.

(51) Int. Cl. G08B 21/00

(52) U.S. Cl. 340/635

(57) ABSTRACT

Monitoring assemblies and methods for wirelessly communicating an operational state of a circuit protector in an electrical circuit.

This application is a continuation-in-part application of U.S. application Ser. No. 11/223,385 filed Sep. 9, 2005 and entitled Circuit Protector Monitoring Assembly. Kit and Method, which claims the benefit of U.S. Provisional Patent Application Ser. No. 60/608,580 filed Sep. 10, 2004 and entitled Methods and System for Circuit Protection, the entire disclosures of which are hereby incorporated by reference in their entirety.

This application also relates to U.S. application Ser. No. 11/223,702 filed Sep. 9, 2005 and entitled System and Method for Circuit Protector Monitoring and Management; U.S. application Ser. No. 11/224,586 filed Sep. 12, 2005 and entitled Circuit Protector Signal Transmission, Methods and System; U.S. application Ser. No. 11/223,618 filed Sep. 9, 2005 and entitled Circuit Protector Monitoring and Management System User Interface Method, System, and Program; U.S. application Ser. No. 11/223,484 filed Sep. 9, 2005 and entitled Multifunctional Handheld Response Tool, Method and System for Circuit Protector Management; and U.S. application Ser. No. 10/828,048, filed Apr. 20, 2004 and entitled Wireless Fuse State Indicator System and Method; and U.S. application Ser. No. 10/973,628 filed Oct. 26, 2004 and entitled Fuse State Indicating and Optical Circuit and System, the complete disclosures of which are hereby incorporated by reference in their entirety.

### BACKGROUND OF THE INVENTION

This invention relates generally to circuit protection devices, and more particularly to systems for managing electrical systems including circuit protection devices.

Electrical systems typically include a number of circuit protection devices that protect electrical circuitry, equipment, and components from damage. Overcurrent protection devices, for example, are constructed to physically open or interrupt a circuit path and isolate electrical components from damage upon the occurrence of specified overcurrent conditions in the circuit. Known circuit protection devices include devices such as fuses, circuit breakers, and limiters, which may address overcurrent, overload, and short circuit conditions in an electrical system, and other switching devices. As the size and complexity of electrical systems increase, the number of associated circuit protection devices also typically increases. Managing a complex electrical system having a large number of circuit breakers, any one of which may operate at any given time to isolate portions of the circuitry in the electrical system, is challenging.

### BRIEF DESCRIPTION OF THE DRAWINGS

FIG. 1 is a schematic block diagram of an exemplary circuit protector management system coupled to an electrical system.

FIG. 2 is a method flowchart for the circuit protector management system shown in FIG. 1.

FIG. 3 is a perspective view of another embodiment of a circuit protector and panel assembly for the circuit protector management system shown in FIG. 1.

FIG. 4 is a schematic block diagram of the monitoring assembly shown in FIG. 3.

FIG. 5 is a perspective view showing internal parts of a module that may be used in the assembly of FIGS. 3 and 4.

FIG. 6 is a schematic block diagram of a networked circuit protection signal transmission system that may be used in the circuit protector management system of FIG. 1.

FIG. 7 schematically illustrates the signal transmission system shown in FIG. 6.

FIG. 8 is a method flowchart for the system shown in FIGS. 6 and 7.

FIG. 9 schematically illustrates a further embodiment of the system shown in FIGS. 6-8.

FIG. 10 is an exemplary schematic block diagram of an exemplary circuit protector management system utilizing the signal transmission system of FIG. 6 and connected to an electrical system.

FIG. 11 is an exemplary site diagram of the electrical system shown in FIG. 10.

FIG. 12 is a schematic block diagram of another embodiment of a monitoring assembly for the system shown in FIG. 1.

FIG. 13 is a schematic block diagram of an alternative networked circuit protection signal transmission system that may be used with monitoring assemblies such as those shown in FIG. 12.

FIG. 14 is a schematic block diagram of the modules shown in FIG. 12 connected to an electrical system and in communication with a management system utilizing the signal transmission system shown in FIG. 13.

### DETAILED DESCRIPTION OF THE INVENTION

Exemplary embodiments of systems and processes that facilitate monitoring and management of circuit protection devices in electrical systems, referred to herein as “circuit protectors”, and systems and processes that facilitate rapid response to specified operating conditions of the circuit protectors and associated circuitry are described below in detail. The systems and processes facilitate, for example, detection of operated circuit protectors, notification to responsible personnel of operated circuit protectors and their location in the system for response and attention by authorized personnel, diagnostics and troubleshooting of circuit protectors and electrical systems, and circuit protector inventory control and management for facilities management. A technical effect of the systems and processes described herein include at least one of organization and presentation of circuit protector information and electrical system data for facilities management and system oversight, real time alarm condition detection and notification for circuit protector operation, automated alert notification and summoning of personnel or site technicians to quickly reset and re-store downed circuitry due to operation of one or more circuit protectors, archived installation and performance data of the circuit protectors and associated electrical system for diagnostics and troubleshooting of electrical system perturbation events, and proactive management of electrical systems in anticipation of potential circuit perturbations.

A. Introduction

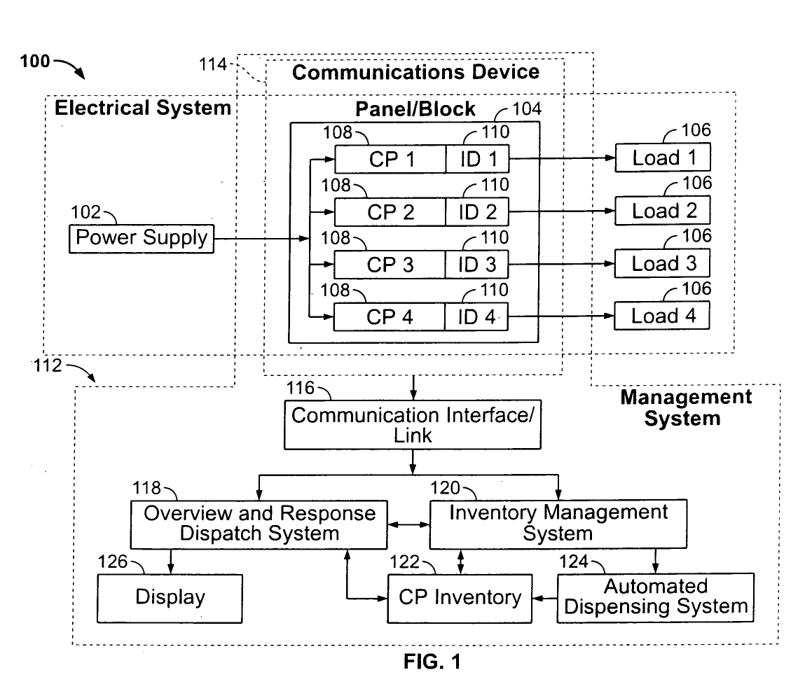

FIG. 1 is a schematic block diagram of an exemplary electrical system 100 representative of the type of system that utilizes circuit protectors. In different embodiments, and as a few examples, the electrical system 100 could be implemented as a battery powered electrical system for a vehicle, an AC or DC power distribution system for a building, industrial plant and/or control system, a communications network, other system as those in the art will appreciate.

In the illustrated embodiment, the electrical system 100 includes a power supply or power supply circuitry 102, a circuit protector panel, a circuit protector holder, a circuit protector block or a circuit protector cabinet (collectively referred to herein as “the panel 104”) coupled to the power supply 102 by a line L, and a number of electrical loads 106 operatively connected to the panel 104. The panel 104 includes one or more circuit protectors 108 that interconnect the power supply 102 to the respective loads 106.

In various embodiments, the loads 106 may include electrical components such as transformers, inductors, integrated circuits; equipment such as machines, electrical motors and drive components, computers, programmable logic control systems; and sub-circuitry of the larger electrical system 100. Additionally, the loads 106 may serve as a secondary power source to additional loads of the same or different electrical systems.

The circuit protectors 108 in an exemplary embodiment are overcurrent protection devices, such as, for example, fuses, circuit breakers and/or switches. Each circuit protector 108 is constructed to physically break, open, or interrupt a circuit path or current path between line and load circuitry and isolate the loads 106, for example, from the power supply circuitry 102 to prevent damage to the loads 106 upon the occurrence of specified current conditions in the circuit, such as overcurrent, overload, and short circuit conditions. When such conditions occur, the circuit protectors 108 prevent current flow between the power supply circuitry 102 and the respective loads 106, protecting them from potential damage attributable to current flow in such conditions. That is, in normal current conditions the circuit protectors 108 are in a current carrying or unopened condition completing an electrical connection through between the power supply 102 and the loads 106, and in response to abnormal or unacceptable current conditions in the circuit, the circuit protectors 108 change or operate to a non-current carrying state, sometimes referred to as an opened or tripped condition breaking the electrical connection between the power supply 102 and the loads 106.

While one circuit protector panel 104 is illustrated in FIG. 1, it is understood that the electrical system 100 may include a plurality of circuit protector panels 104 in different embodiments. The panels 104 may be located in the same or different physical locations, and each of the circuit protectors 108 is associated with specific electrical loads 106 of the system. While four circuit protectors 108 are illustrated in the panel 104 for ease of illustration, it is contemplated that greater or fewer circuit protectors 108, including a single circuit protector 108, may be employed in the panel 104. That is, the circuit protector panel 104 may be configured or adapted to connect a single circuit protector 108 to the system 100, or alternatively may be adapted to connect a plurality of circuit protectors 108 as those in the art will appreciate.

In complex electrical systems, many circuit protectors 108 are typically required in different panels 104 of various sizes and configurations. Also, complex electrical systems typically include various types and configurations of circuit protectors 108 to meet particular needs of the loads 106 and associated electrical subsystems. The combination of large numbers of circuit protectors 108, assorted numbers of panels 104 in different locations, and various types of circuit protectors 108 in the electrical system 100 presents difficult problems in locating operated circuit protectors 108 and resetting or restoring the circuitry when one or more of the circuit protectors 108 in the electrical system 100 operates to protect the associated loads 106 in the system 100.

As the size and complexity of electrical system 100 increases, the potential locations of circuit protectors 108 in the system 100 increases too. The panels 104 containing the circuit protectors 108 may be located in different places in the electrical system 100, including different buildings, areas, compartments and portions of the electrical system site or facility. Therefore, when one or more circuit protectors 108 operate to open a portion of the circuitry in the electrical system 100, it can be a daunting task to locate which of the circuit protector devices 108 has operated, and to take corrective action to reset or restore affected circuitry and loads 106.

An elapsed time between operation of one or more circuit protectors 108 and re-energizing of the associated circuitry to restore full operation of the electrical system 100 is significant in many applications. For example, in an industrial plant control system or office building, the time in which affected machines or computers are unavailable due to operated circuit protection devices amounts to lost productivity and economic loss. For virtually any electrical system, and especially for critical electrical systems, minimizing the time and effort required to locate operated circuit protectors 108 and to take corrective action is desired.

When the circuit protectors 108 are circuit breakers, once the appropriate location of an operated circuit breaker has been identified, the breaker or breakers can generally be quickly reset. Locating the correct breakers, however, is not always a quick or easy task when there are a large number of breakers in different locations or panels 104 in the electrical system 100. To locate the operated breakers quickly, downed circuitry or equipment typically is matched with the appropriate breakers of the system 100, which requires some detailed knowledge of the electrical system 100 that maintenance personnel may or may not have at any given time. Alternatively, and probably more likely in most cases, maintenance personnel systematically inspect all of the circuit protector breakers in the electrical system to locate tripped breakers. Such an exercise is usually inefficient, except perhaps in situations where by mere chance the personnel starts the inspection in the area of the operated breakers. Also, locating tripped breakers can be complicated when breakers in more than one location are tripped, and in the case of faulty or inoperative breakers which are not tripped, restoring the circuitry of the electrical system 100 when one or more of the circuit protectors 108 operates can be extremely difficult and time intensive.

When the circuit protectors 108 include fuses, operated fuses must be located, replacement fuses must be obtained, and the operated fuses must be replaced to reset the circuitry of the electrical system 100. If a replacement fuse is on hand and the location of the operated fuse is known, the fuse can typically be quickly replaced to restore the circuitry. Locating which fuse or fuses has opened, however, and obtaining the proper replacement fuses, is not always easy. Fuses of different types may be located in various places throughout the electrical system 100, and locating the proper replacement fuse from a large inventory of different fuse types, whether on site or at a remote location, can be time intensive. As with circuit breakers, locating operated fuses can be complicated when more than one fuse operates, and locating faulty fuses or improperly installed fuses in the electrical system 100 can be extremely difficult. Additionally, properly managing, maintaining, and replenishing a replacement fuse inventory to meet actual and anticipated needs of the electrical system 100 can be difficult.

In addition, circuit protectors 108 tend to operate with little or no advanced warning. Thus, troubleshooting the electrical system 100 and/or taking preemptive action before the circuit protectors 108 operate is difficult, if not impossible, in many electrical systems. Additionally, diagnosing the electrical system 100 to determine why or how certain circuit protectors 108 operated is often an after-the-fact analysis and can be speculative in nature.

B. The Circuit Protector Management System.

In an exemplary embodiment, and to alleviate these and other difficulties, each of the circuit protectors 108 is associated with a status element 110 located internal or external to the circuit protector 108. That is, the status element 110 may be located interior to or inside the circuit protector 108, on an external surface of or otherwise outside of the circuit protector 108, or even at another location at a distance from the circuit protector 108. As described further below, in different embodiments the status elements 110 may be implemented in electronic form or be mechanically actuated to interface the status elements 110 to the circuit protector management system 112. When a circuit protector 108 operates to open a circuit path in the electrical system 100, the associated status element 110 aids in identifying the circuit protector so that the circuitry can be efficiently re-energized with minimal time delay.

Each of the status elements 110 of the circuit protectors 108 is responsive to operation of the respective circuit protector 108, and in exemplary embodiments the status elements 110 transmit or communicate signals or data to an circuit protector management system 112. The status elements 110 in some embodiments may be used as data collectors regarding operating conditions of the circuitry in the electrical system 100, as explained further below.

In an exemplary embodiment, the circuit protector management system 112 may include in whole or in part a communications device 114 in communication with the status elements 110 of the circuit protectors 108, a communications interface or link 116, an overview and response dispatch system 118 in communication with the link 116, and an inventory management system 120 in communication with the link 116 and/or the overview and response dispatch system 118.

During operation of the electrical system 100, signals are sent from the status elements 110 of the circuit protectors 108, through the communications device 114 and the communication link 116, to the overview and response dispatch system 118. The communications device 114 allows the status elements 110 associated with the circuit protectors 108 to communicate with the overview and response dispatch system 118 and the inventory management system 120 via the communications interface 116. In particular, when any of the circuit protectors 108 operates to interrupt, break, or open a circuit path to one or more of the loads 106, a signal is communicated from the respective identification element 112 via the communications device 114 and the communication link 116 to the overview and response dispatch system 118 and/or to the inventory management system 120.

The overview and response dispatch system 118 and/or the inventory management system 120 are, in turn, associated with an inventory 122 of circuit protectors and an automated or manual dispensing system 124 for stocking and replenishing the inventory 122 as the inventory is used. The inventory 122 may be located on site or at another location from the electrical system 100.

In an exemplary embodiment, the communications device 114 is located proximate to the circuit protectors 108, either integrated into the construction of the panel 104 or in a location proximate to the panel 104. The communications interface or link 116 may be a hard-wired communications link, optical link, wireless communications link, satellite link, and equivalents thereof as explained further below. Additionally, the communications interface or link 116 may utilize existing infrastructure in the electrical system 100, and may operate, for example, using known power line frequency carrier technology or equivalents thereof over existing wires and conductors in the electrical system 100. Combinations of such communications links may likewise be provided in different embodiments of the management system 112.

The communications link 116 may be a dedicated interface or link used only for circuit protector management purposes by the management system 112, or may also serve other unrelated purposes and be used for transmission of other signals, data and communications as desired. Communication between the communications device 114 and the overview and response dispatch system 118 may be established using known data transmission protocols and network communication technologies such as DeviceNet and Datahiway protocols. Ethernet connections multiplexing communication schemes, wireless technologies, satellite transmission schemes, equivalents thereof, and the like may also be used as those in the art will appreciate.

While one communications device 114 is illustrated in FIG. 1, it is contemplated that more than one communications device 114 may be employed in the circuit protector management system 112. Multiple communication devices 114 may furthermore be employed in the same panel 104 depending upon the number of circuit protectors 108 in the panel 104 and the sophistication of the management system 112. In exemplary embodiments, as further explained below, one communication device 114 may be used to monitor multiple circuit protectors 108 and transmit information to the overview and response dispatch system 118.

In various embodiments, the overview and response dispatch system 118 may be a network-based system, a personal computer, a computer workstation, a programmable logic controller or other electronic controller, a processor-based hand held device or another electronic device or equivalent that may receive and process or interpret signals from the link 116. In one embodiment, the overview and response dispatch system 118 may include a user display 126 to alert an operator or maintenance personnel of an issue with the electrical system 100, such as an operated circuit protector 108 which has broken a circuit path in the electrical system 100.

In different embodiments, the inventory management system 120 is a network-based computer system, a personal computer, a computer workstation, a processor-based hand held device, a programmable logic controller or an electronic controller or other electronic device which receives signals from the link 116 and/or the overview and response dispatch system 118 and is capable of responding appropriately. The inventory management system 120 may be integrated into the overview and response dispatch system 118 as desired, or may be a separate device in the same or different location from the overview and response dispatch system 118. The inventory management system 120 is associated, directly or indirectly, with the inventory 122, and is in communication with the automated dispensing system 124. The automated dispensing system 124 may be of a known type currently used in industrial and business facilities to provide uninterrupted access to supplies. Such automated dispensing systems are commercially available and sometimes referred to as Smart Inventory Systems. The automated dispensing system 124 electronically receives and processes orders for circuit protection products so that the product orders are filled and the circuit protection products are delivered to the inventory 122 with minimal delay. Alternatively, a manual inventory system may be employed to dispense and replenish the circuit protection devices.

While one automated dispensing system 124 is shown in FIG. 1, it is appreciated that the overview and response dispatch system 118 and inventory management system 120 may communicate with more than one automated dispensing system 124 to obtain inventory products from the same or different circuit protection product vendors, distributors or suppliers as desired. Additionally, the overview and response dispatch system may communicate with known computerized maintenance management system (CMMS), supervisory control and data acquisition (SCADA) systems, industrial control and automation systems, enterprise resource planning (ERP) systems, Electronic Data Interchange (EDI) systems, Manufacturing Resources Planning (MRP) systems, and supply chain management systems in addition to or in lieu of the inventory management system 120.

By virtue of the status elements 110 associated with the fuses 108, and as further explained below, the overview and response dispatch system 118 may direct an operator or maintenance personnel to a precise location and to one or more specific circuit protectors 108 in the electrical system 100 for resetting or restoring the circuitry. Additionally, the overview and response dispatch system 118 may locate proper replacement circuit protectors in the inventory 122 and direct personnel to a precise location to obtain the proper replacement circuit protectors, while contemporaneously ordering additional circuit protectors via the manual or automated dispensing system 124 to replenish the inventory 122 as it is used. Thus, the electronic management system 112 can provide precise instruction to personnel regarding the circuit protectors 108 to minimize down time of the associated load 106 for the operated circuit protector 112. The circuit protectors 108 may therefore be attended to as efficiently as possible, and automated ordering of replacement parts for the circuit protector inventory 122 ensures prompt replenishing of the inventory and eliminates error in inventory management. Factory automation technologies and equivalents thereof may be used to ensure that replacement circuit protectors are available for use and pinpoint their location in a physical plant for retrieval by maintenance personnel, and inventory management is accomplished in an automated manner without human intervention or action by maintenance personnel.

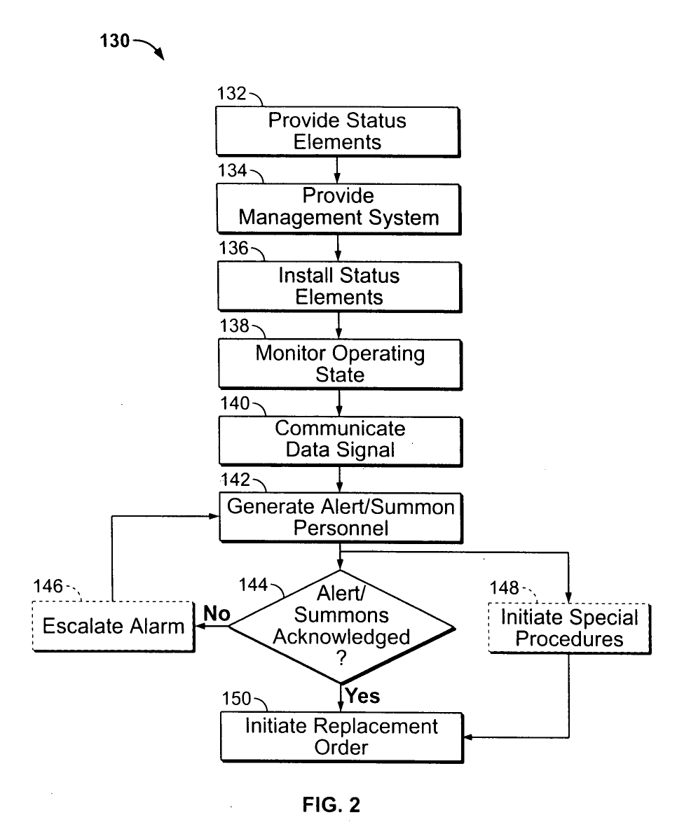

FIG. 2 is a flowchart of an exemplary method 130 for monitoring circuit protectors 108 utilized the circuit protector management system 112 shown in FIG. 1. The method 130 facilitates efficient re-energizing affected circuitry in an electrical system 100 when one or more of the circuit protectors 108 operates to isolate one portion of an electrical system 100 from another portion of the electrical system 100, such as isolating one or more of the loads 106 from the power supply 102.

In an exemplary embodiment, the method 130 includes providing 132 status elements, embodiments of which are explained below, proximate to the respective circuit protectors of interest in the electrical system, and providing 134 the electronic overview and response dispatch system responsive to the status elements. Once the status elements are installed 136, they may be used to monitor 138 an operating state of the circuit protectors.

Based upon the sensed state of the circuit protectors, a data signal may be transmitted 140 from at least one of the status elements to a remote device or location when one of the circuit protectors has operated to isolate a portion of the electrical system. The data signal, may include, for example, an identification code and an address code to identify the location of the operated circuit protector, and detailed information and instruction to appropriate personnel to reset or restore the circuitry quickly and efficiently. When interpreted at the remote location by the overview and response dispatch system, the data signal may be converted to an instruction to an operator or technician that may include, for example, information regarding the location of operated circuit protectors, information needed to properly reset or restore the circuitry affected by the operated circuit protectors, inventory information for replacement circuit protectors needed to properly restore the circuitry, and information pertaining to operating conditions of the circuitry for diagnostic and troubleshooting purposes. The instruction to personnel may further include specific information regarding potential hazards in the location of the circuit protector, and information regarding precautions that should be taken and personal protection equipment that should be utilized when responding to an operated circuit protector.

In response to the data signals communicated 140 to the overview and response dispatch system, the overview and response dispatch system generates 142 an alert and summons to responsible personnel, informing them of the operated circuit protector and the location of the operated circuit protector. For example, the overview and response dispatch system may directly communicate with an operator, maintenance personnel, or others via a remote device such as a computer, pager, dispatcher, a hand-held device such as a personal digital assistant (PDA), personal information manager (PIM), or electronic organizer, cellular phone or equivalent device which is either networked with the overview and response dispatch system or in communication with the overview and response dispatch system and capable of reaching appropriate personnel. That is, the overview and response dispatch system may be active instead of passive, and instead of simply providing an alert and waiting for human response, the overview and response dispatch system is capable of actually seeking and directly contacting specific persons in multiple ways, and summoning them to respond and intervene as needed to properly manage the electrical system.

The alert and summons may be provided, for example, in an email notification, a fax notification, a pager notification, a web page notification, a voice notification, or other means. The overview and response dispatch system may wait 144 for acknowledgment of the alert and summons by one or more of the designated personnel, and if no acknowledgement is received, another alert and summons is sent. Optionally, the overview and response dispatch system may escalate 146 the frequency or intensity of the alerts and summons depending upon responsiveness of the designated personnel or actual operating conditions of the electrical system. For example, if multiple circuit protectors open at about the same time, a larger problem with the electrical system could be implicated and the management system may more urgently generate alarms, alerts and summons to address potential problems.

Optionally, the overview and response dispatch system may also automatically undertake and initiate 148 other desired actions without human intervention, such as activating auxiliary power to the affected loads corresponding to specific machines or equipment, shutting down at risk systems or loads corresponding to specific machines or equipment, saving key circuit data for analysis, etc. when the circuit protectors 108 operate to open portions of the electrical system 100, and communicating such undertakings and actions to designated personnel for further evaluation and response.

More than one person may be contacted by the overview and response dispatch system and summoned to help re-energize affected circuitry, for example, by replacing operated fuses. Alerts and requests for action by designated personnel may be sent repeatedly from the overview and response dispatch system within specified time periods until acknowledged by appropriate personnel, and escalated alerts and summons may be generated and special procedures implemented as appropriate to deal with different situations depending upon the sophistication of the circuit protector management system 112.

Because the alert and notifications are sent more or less contemporaneously with the operation of the circuit protectors, and because the overview and response dispatch system actively attempts to find, contact and summon personnel and provides complete information needed to re-energize affected circuitry, including at least the type and location of operated circuit protectors, downed circuitry may be quickly re-energized and the full electrical system restored in as quick a time as possible. Automated alerts and summons may be sent around the clock without human intervention as needs arise. The information pertaining to operated circuit protectors can be presented to the end user in an easy to use tabular or graphical form in real time as the circuit protectors operate, and the end recipient of the information need not gather additional information to complete the task of re-energizing circuitry.

By actively seeking and contacting appropriate personnel, as opposed to a reactive system that is dependent upon human response, the overview and response dispatch system is not dependent upon specific persons and designated personnel being in any specific location, such as a workstation, terminal, or working area to receive an alert notification of an operated circuit protector. Rather, the overview and response dispatch system directly seeks out designated persons and contacts them wherever they may be found. Thus, should the persons or personnel be away from a desk, workstation, terminal or working area during working or non-working hours, the overview and response dispatch system is capable of reaching them by other means and instantly notifying them of operated circuit protectors, rather than having to wait for them to return to receive an alert message at their desk, workstation, terminal or working area.

When used as data collectors, the status elements may facilitate monitoring, troubleshooting, and diagnosis of the electrical system as the circuit protectors are monitored 138 and signals are communicated 140 to the overview and response dispatch system. Through monitoring and analysis of such data, potential problems in the system may be more accurately identified and resolved, and more reliable operation of the electrical system may be achieved. In such an embodiment, the alert or summons generated 142 by the overview and response dispatch system may include a warning or alarm to system operators or personnel to anticipate potential circuit opening events and circuit perturbations that may otherwise cause the circuit protectors to operate, potentially providing time for preemptive measures to be taken before one or more of the circuit protectors operate to break the associated circuit paths in the electrical system. The associated time, cost, expense and inconvenience of opened circuitry in the electrical system and the associated time, cost, expense and inconvenience involved in resetting, restoring or re-energizing the circuitry due to operated circuit protectors may therefore potentially be avoided in the first instance with proactive management of the electrical system.

The overview and response dispatch system may further initiate 150 a replacement order to replenish, for example, a fuse inventory when the operated fuse or fuses in the electrical system has been replaced.

C. The Status Elements and Circuit Protector Monitoring

It is contemplated that may different status elements and circuit protector monitoring assemblies may be provided in the circuit protector management system 112. Exemplary embodiments will now be described for illustrative purposes only. It is understood that other monitoring assemblies may be used in addition to the examples set forth below with equal effect.

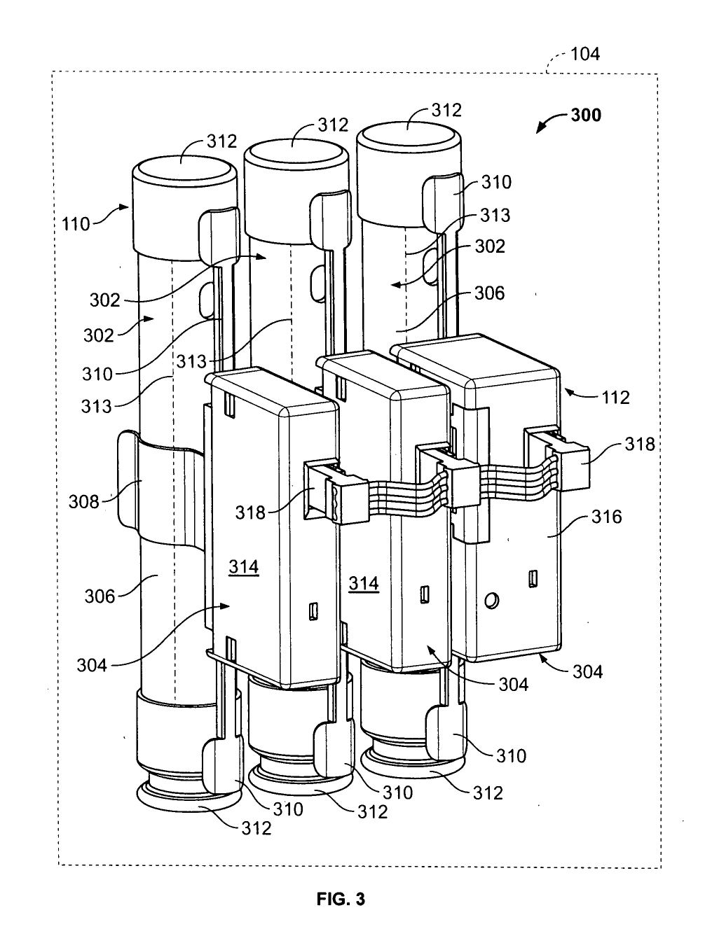

FIG. 3 is a perspective view of an exemplary circuit protector 108 and panel 104 that may be used in the circuit protector management system 112 and the method 130 wherein the status elements 110 are provided in the form of a monitoring module assembly 300. The monitoring module assembly 300 is associated with a plurality of circuit protectors in the form of fuses 302, and the assembly includes a plurality of monitoring modules 304 that are attached to the bodies 306 of the respective fuses 302. In an exemplary embodiment, the monitoring modules 304 are individually mounted to the fuse bodies 306 via a clip 308 to an exterior surface of the respective fuse bodies 306, thereby facilitating retrofit installation to the fuses 302 in an electrical system. As previously explained, the fuses 302 may be housed and arranged in the panel 104 in the electrical system to interconnect power supply circuitry 102 and various loads 106 in the electrical system.

The monitoring modules 304 may each include contact arms 310 extending outwardly from the modules 304 in a direction substantially parallel to the respective fuse body 306. The contact arms 310 of the respective modules 304 mechanically and electrically engage the terminal elements 312 of the fuses 302 so that the fuses 302 may be monitored in use. A primary fuse element 313 defines an interruptible current path between the terminal elements 312 of each of the fuses 302, and when the current path is opened or interrupted in an overcurrent condition, the modules 304 sense the operation of the fuses 302 in real time.

In an exemplary embodiment, the monitoring modules 304 include sensor modules 314 associated with some of the fuses 302 and a communications module 316 associated with one of the fuses 302. The sensor modules 314 and the communications module 316 may be interconnected to one another via interface plugs 318 and three wire connections, for example, as illustrated in FIG. 3.

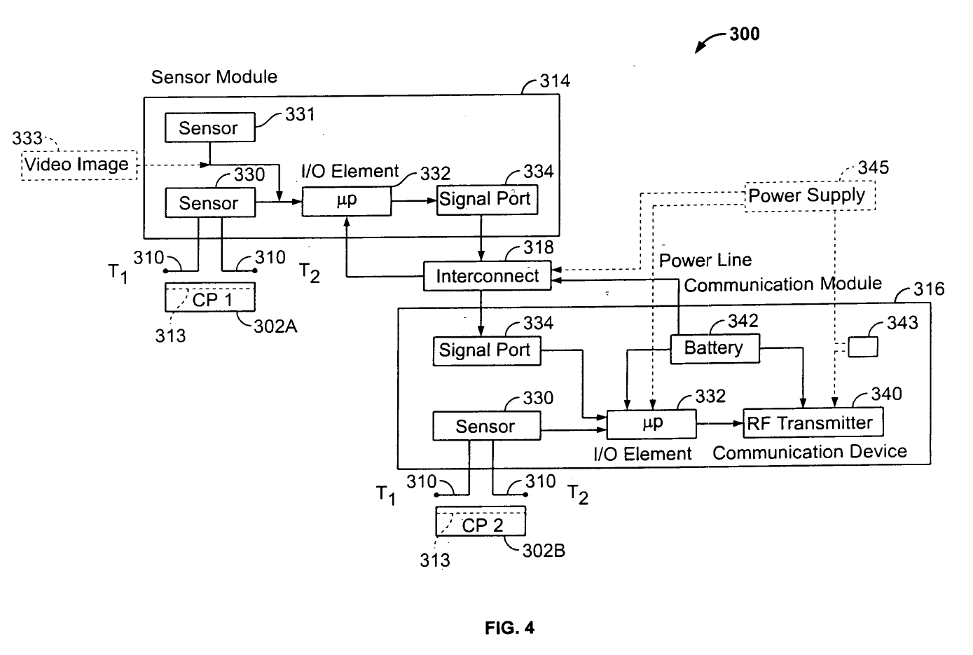

Referring now to FIG. 4, the construction of the sensor modules 314 and the communications module 316 will be described. Each sensor module 314 includes a sensor 330, an input/output element 332 connected to the sensor 330, and a signal port 334. The sensor 330 is connected to the contact arms 310 that are connected to the terminal elements T₁ and T₂ of one of the circuit protector fuses 302A. In one embodiment, the sensor 330 is a voltage sensing latch circuit having first and second portions optically isolated from one another. When the primary fuse element 313 of the fuse 302A opens to interrupt the current path through the fuse 302A, the sensor 330 detects the voltage drop across the terminal elements T₁ and T₂ of the fuse 302A. The voltage drop causes one of the circuit portions, for example, to latch high and provide an input signal to the input/output element 332. Acceptable sensing technology for the sensor 330 is available from, for example, SymCom, Inc. of Rapid City, S. Dak.

While in the exemplary embodiment, the sensor 330 is a voltage sensor, it is understood that other types of sensing could be used in alternative embodiments to monitor and sense an operating state of the circuit protector 302A, including but not limited to current temperatures and temperature sensors that could be used to determine whether the primary fuse element 313 has been interrupted in an overcurrent condition to isolate a portion of the associated electrical system.

In a further embodiment, one or more additional sensors or transducers 331 may be provided, internal or external to the sensor module 314, to collect data of interest with respect to the electrical system and the load connected to the fuse 302A. For example, sensors or transducers 331 may be adapted to monitor and sense vibration and displacement conditions, mechanical stress and strain conditions, acoustical emissions and noise conditions, thermal imagery and thermalography states, electrical resistance, pressure conditions, and humidity conditions in the vicinity of the fuse 302A and connected loads. The sensors or transducers 331 may be coupled to the input/output device 332 as signal inputs. Video imaging and surveillance devices 333 may also be provided to supply video data and inputs to the input/output element 332.

In an exemplary embodiment, the input/output element 332 may be a microcontroller having a microprocessor or equivalent electronic package that receives the input signal from the sensor 330 when the fuse 302A has operated to interrupt the current path through the fuse 302A. The input/output element 332, in response to the input signal from the sensor 330, generates a data packet in a predetermined message protocol and outputs the data packet to the signal port 334. The data packet may be formatted in any desirable protocol, but in an exemplary embodiment includes at least an identification code, a fault code, and a location or address code in the data packet so that the operated fuse may be readily identified and its status confirmed, together with its location in the electrical system. Of course, the data packet could contain other information and codes of interest, including but not limited to system test codes, data collection codes, security codes and the like that is desirable or advantageous in the communications protocol.

Additionally, signal inputs from the sensor or transducer 331 may be input the input/output element 332, and the input/output element 332 may generate a data packet in a predetermined message protocol and output the data packet to the signal port 334. The data packet may include, for example, codes relating to vibration and displacement conditions, mechanical stress and strain conditions, acoustical emissions and noise conditions, thermal imagery and thermalography states, electrical resistance, pressure conditions, and humidity conditions in the vicinity of the fuse 302A and connected loads. Video and imaging data, supplied by the imaging and surveillance devices 333 may also be provided in the data packet.

The communications module 316 in an exemplary embodiment may also include a sensor 330, an input/output element 332, and a signal port 334. Like the sensor module 314, the sensor 330 of the communications module 316 is connected to the contact arms 310 that are connected to the terminal elements T₁ and T₂ of one of the circuit protector fuse 302B, and the sensor 330 of the communications module 316 operates substantially in the same manner as described above to sense an operating state of a primary fuse element 313 in the fuse 302B. However, when the sensor 330 detects operation of the fuse 302B, the input/output element 332 generates and outputs a corresponding data packet to a transmitter 340 that communicates with the overview and response dispatch system 118. The transmitted data packet from the communications module 316, in addition to the data packet codes described above, also includes a unique transmitter identifier code so that the overview and response dispatch system may identify the particular communications module 316 that is sending a data packet.

In one embodiment, the transmitter 340 is a low power radio frequency (RF) signal transmitter that digitally transmits the data packet in a wireless manner. Point-to-point wiring in the electrical system for fuse monitoring systems is therefore avoided, although it is understood that point-to-point wiring could be utilized in some embodiments of the invention. Additionally, while a low power digital radio frequency transmitter has been specifically described, it is understood that any of the aforementioned wireless communication schemes and equivalents could alternatively be used if desired.

The communications module 316 further includes an on-board battery power supply 342 that powers the electronic sensor 330 and/or the input/output element 332 and the transmitter 340 of the communications module 316. The battery 342 may also supply power, through the interface plugs 318, to the input/output element 332 and/or the sensor 330 of the communications module 316. Thus, multiple sensor modules 314 may be powered by a single communications module 316 to monitor a plurality of fuses 302. For example, one of the three wire connections shown in FIG. 3 may be a power line connecting the battery 342 to one or more sensor modules 314. The battery 342 may be replaceable as needed to extend the life of the monitoring assembly 300, and a test button, for example, may be provided in the communications module 316 to ensure that the battery 342 is powered and the module electronics in the communications module 316 and connected sensor modules 314 are working properly. Reset buttons may also be provided in the modules for testing and diagnostic purposes. A power harvesting device 343, such as rechargeable batteries and the like that store energy when not in use may be utilized in addition to or in lieu of the battery 342. A backup power supply 345, or other circuits of the electrical system may also be used to power the sensor and communications modules 314, 316. Energy storage components such as capacitors may also be employed, and switching devices may be provided to switch between energy storage elements, power harvesting devices, batteries, and backup power supplies, or other circuitry to power communications after circuit protector 302A has operated.

Also, the signal port 334 of the sensor module 314 may communicate, via the interface plug 318 with the signal port 334 of the communications module 316. Thus, for example, considering the embodiment of FIG. 4, when the primary fuse element 313 opens in the fuse 302A associated with the sensor module 314, the sensor module input/output element 332 generates a data packet that is sent to the sensor module signal port 334 through the interface plug 318 and to the communications module input/output element 332 for transmission via the transmitter 340. Thus, signals are simply passed through the respective signal ports 334 via the interface plug 318, and multiple sensor modules 314 may be connected to a single communications module 316 via interconnecting the interface plugs 318 to the signal ports 334. In such a manner, the number of communication modules 316 and transmitters 340 in the circuit protector management system may be reduced, together with associated costs and maintenance issues.

Additionally, status indicators and the like such as light emitting diodes (LED's) may be provided in the sensor and communication modules 314, 316 to locally indicate an operated fuse 302. Thus, when maintenance personnel arrives at the location of the operated fuse 302, the status indicators may provide local state identification of the fuses associated with the modules 314, 316.

Notably, the monitoring modules 304, including the sensor modules 314 and communications modules 316 are provided in modular form wherein different sized mounting clips 308 and differently dimensioned contact arms 310 may be provided to accommodate fuses of varying sizes and configurations. By providing various mounting clips and mounting structure, together with various contact arms and contact structure to establish electrical contact with the fuses, the modules 304 are readily adaptable to accommodate most if, not all, types of fuses, and the modules 304 may be retrofitted to complex electrical systems with snap-on engagement, thereby minimizing installation time and complexity in existing electrical systems.

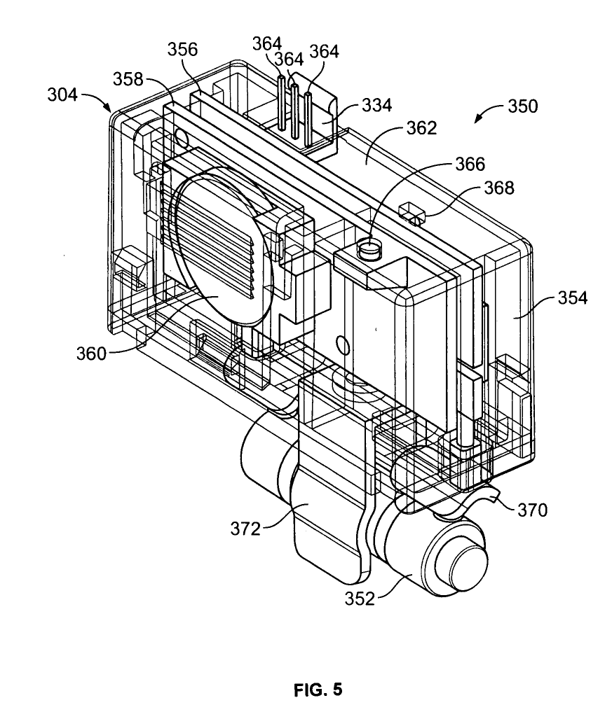

FIG. 5, for example, illustrates a single phase monitoring assembly 350 including a monitoring module 304 and a circuit protector in the form of a fuse 352. The module 304 includes a body or housing 354, a sensor board 356, a communications board 358, and a battery 360 mounted therein and forming a protective enclosure thereabout. The sensor board 356 includes, for example, sensing circuitry 330 to detect operation of the fuse, such as the aforementioned voltage sensing, current sensing, or temperature sensing circuitry, and the communications board includes, for example, the input/output element 332 and the transmitter 340 for generating data messages and signals when the fuse 352 operates to open the circuit.

The signal port 334 is exposed through an outer surface 362 of the module 304, and in an exemplary embodiment, the signal port 334 includes contacts 364 that interface with, for example, mating interconnect plugs such as the plugs 318. The module 304 may therefore be connected to another monitoring module 304 in the larger electrical system.

With the communications board 358 and battery 360, the module 304 may function as the communications module 316 described above. Without the communications board 358 and battery 360, the module 304 may function as a sensor module 314 as described above. The communications board 358 may include a low power radio frequency transmitter as described above, or may alternatively communicate with a remote device by any of the aforementioned methods.

A test/reset button 366 extends through the outer surface 362 of the housing 354, and a status indicator opening 368 is provided in the outer surface 362. A light emitting diode (LED), for example, may be connected to the sensor board 356 and may be illuminated when the fuse 352 opens to isolate a portion of electrical circuitry connected thereto, thereby providing visible local indication in the housing 354. Contact arms 370 are attached to the housing 354 and are electrically connected to the sensor board 356 for monitoring of the fuse 352 when the contact arms 370 are mechanically engaged to the terminal elements of the fuse 352.

A mounting element 372 attaches to the exterior surface of the fuse body, thereby permitting retrofit installation to the fuse 352 when the fuse 352 is installed in an electrical system.

Various adaptations of the monitoring modules 304 may be made to use the modules 304 on various types of circuit protectors and systems. For example, modules suitable for single phase, three phase, and polyphase circuit breaker systems may be provided. Modules may be provided as sensor modules or communication modules. Various types of contact arms and mounting structure may be provided for use with various types of circuit protectors and for circuit protectors of varying size, and the modules may be provided in kit form having various interchangeable component parts that may be assembled to meet the needs of a variety of circuit protectors. Such kits may be assembled quickly by hand and without tools due to snap-fit connections, for example, of such component parts, thereby providing a convenient and low cost monitoring assembly for circuit protectors. Modular construction and assembly of the monitoring modules, mounting elements and contact arms permits wide application of the monitoring modules to existing electrical systems having fuses of various sizes, shapes and configurations. When used in a circuit protector management system 112 such as that described above to communicate signals to the overview and response dispatch system 118, the monitoring modules and monitoring assemblies provide an effective monitoring status and detection scheme for an electrical system having a variety of different types of circuit protectors.

A versatile, relatively low cost, expandable and adaptable circuit protector monitoring system is therefore provided that may be retrofitted to existing electrical systems without modifying the electrical system and infrastructure. It is understood, however, that in future equipment, or perhaps for smaller electrical systems, the monitoring, communications, and management components could be built-in to the electrical system and circuit protector products themselves.

While the foregoing embodiments of panels 104 and circuit protectors 108 are described in the context of fuses, similar technologies and methodologies could be employed with other types of circuit protectors such as, for example, circuit breakers and switches to detect operation of the devices to more efficiently locate and reset tripped breakers and opened switch paths, as well as to facilitate monitoring, diagnostics and troubleshooting of the electrical system.

D. The Signal Transmission System

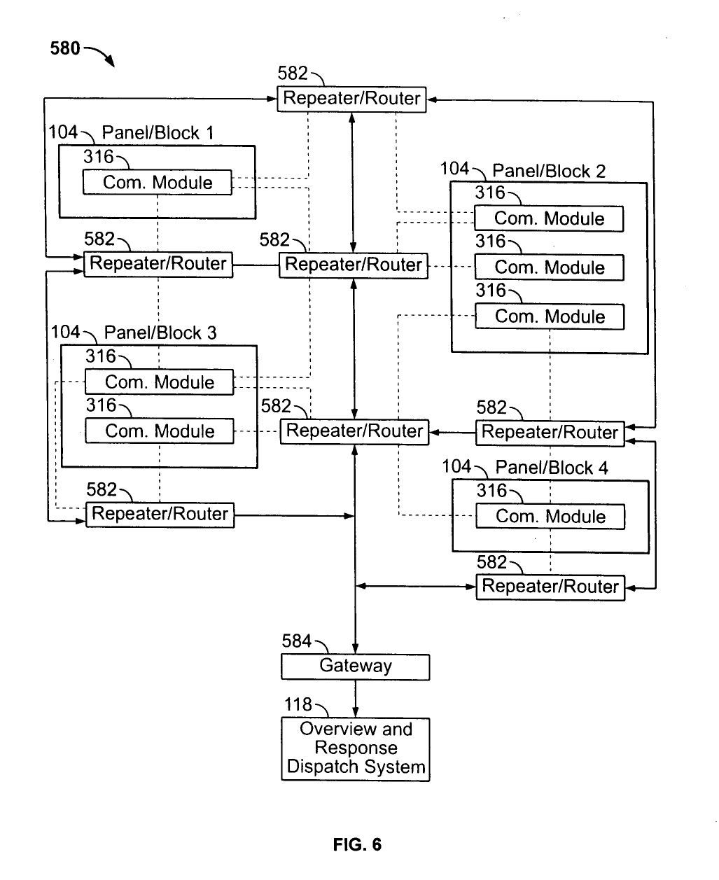

FIG. 6 schematically illustrates an exemplary signal transmission system 580 for use with the circuit protector management system 112 shown in FIG. 1 and the method 130 shown in FIG. 2. A plurality of circuit protector panels 104 are distributed throughout the electrical system, and each circuit protector panel 104 in the electrical system that is to be monitored includes, for example, a monitoring assembly such as those described above for transmitting data signals corresponding to the operational state one or more circuit protectors, such as fuses, in the panels 104. In the manner described above, the communications module 316 generates a wireless data signal or data packet when one of the fuses associated with the monitoring assemblies opens. In an exemplary application, the monitoring assemblies include the communications modules 316 describe above.

The wireless data signals from the communications modules 316 may be received, for example, by one or more repeater/router elements 582 located within the transmission range of the communications module transmitter 340. In an exemplary embodiment, the repeater/router elements 582 may be wireless, radio frequency transmission devices or equivalent devices that receive, for example, a digitally transmitted RF data signal from the communications module 316 and forward the data signal to a signal collection and conditioning device, referred to herein as a gateway device 584. The gateway device is, in turn, in communication with the overview and response dispatch system 118. Alternatively, the repeater/router elements 582 may be another electronic device that functions to feed transmitted data from the communications module 316 to the gateway device 584. For example, USB, serial port connections or other connection means and their equivalents may be utilized to interconnect the repeater/router elements 582 and the gateway device 584.

In an exemplary embodiment, a plurality of repeater/router elements 582 are provided around and about the various panels 104, and the repeater/router elements 582 form a mesh network defining multiple signal paths to forward signal transmissions from the communication modules to a single gateway device 584 in communication with the overview and response dispatch system 118. Repeater/router elements 582 and mesh network configurations are commercially available from, for example, RF Monolithics, Inc. of Dallas, Tex. Many different mesh topologies are known and may be employed, including but not limited to star configurations, ring configurations, cloud configurations, linear configurations and the like. The mesh network may be algorithmically based and configured to meet specific needs for specific installations.

The network of repeater/router elements 582 in one embodiment is self-configuring and self healing with autorouting and rerouting capability as the network changes, and is highly scalable wherein thousands of circuit protectors may be monitored in the circuit protector management system 112. Considering that the various panels 104 may be located in different locations, and even in different buildings, the management system 112 is versatile and adaptable to existing electrical systems 100, and is accommodating to addition or subtraction of additional electrical loads and circuit protectors in the electrical system.

While a plurality of repeater/router elements 582 are illustrated in FIG. 6, it is understood that as few as one repeater/router element 582 could be provided in an alternative embodiment. Likewise, more than one gateway device 584 could be employed if desired.

The gateway device 584 may be a network based computer server system, a personal computer, a computer workstation, a programmable logic controller or other electronic controller, a processor-based hand held device or another electronic device or equivalent thereof that may receive, condition, process or interpret signals from repeater/router elements 582, and communicate the signals to the overview and response dispatch system 118.

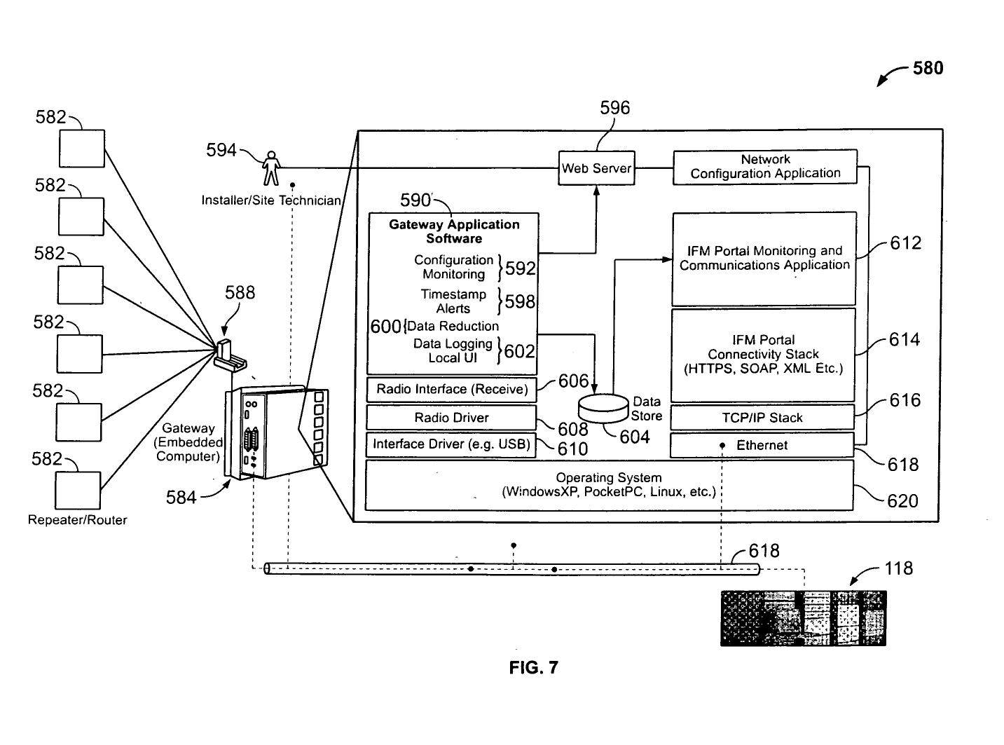

FIG. 7 schematically illustrates the signal transmission system 580 providing data communication between the repeater/router elements 582 and the overview and response dispatch system 118 via the gateway device 584.

As shown in FIG. 7, the gateway device 584 may be an embedded computer device including a receiver 588 for receiving, for example, wireless data transmission from the repeater/router elements 582 when one or more of the status elements, such as the monitoring modules 304 described above signal the repeater/router elements 582 of an operated circuit protector that has isolated portions of electrical circuitry in an electrical system. The receiver 588 may be a part of the gateway device 584 or may be separately provided and interfaced with the gateway device 584 to receive incoming signal transmissions from the repeater/router elements 582.

Data packets may be transmitted repeatedly from the circuit protector monitoring assemblies and/or the repeater/router elements 582 within specified time periods to ensure that the data packets are completely received, processed, and optionally acknowledged by a gateway device 584 and/or the overview and response dispatch system 118. Repeated transmission of data signals avoids collision of signals when more than one of the circuit protectors operates at approximately the same time. Also, the repeater/router elements 582 may add a routing code, a time stamp or other information to the data packet so that the overview and response dispatch system 118 may monitor the communication system and signal path between the monitoring modules and the overview and response dispatch system 118.

As shown in FIG. 7, the gateway device 584 includes gateway application software 590 for processing incoming data signals through the repeater/router elements 582. The gateway application software may be implemented on, for example a Linux, UNIX or Windows-based operating system and equivalents thereof as those in the art will appreciate.

The application software 590 may include, for example, configuration and monitoring algorithms 592 and interactive graphic user displays for assisting the monitoring assembly installers and system or site technicians 594 with setting up, testing and troubleshooting the communications between the status elements, the repeater/router elements 582 and the gateway device 584. The installers or technicians 594 may be logged on to the gateway device 584 at a remote location from the gateway device through, for example, a web server 596 connected to the gateway device 584, or installers or technicians may work directly with a local user interface associated with the gateway device 584 itself. More than one installer or technician could log on to the gateway device 584 for access to the application software 590 to supply and receive necessary information to install, maintain, or modify the configuration of the monitoring components and the signal transmission components associated with circuit protectors.

Using the configuration and monitoring algorithms 592 and interactive graphic user displays, status elements and repeater/router elements may be deemed, considered, determined or identified by the system according to an operating mode thereof. For example, applicable monitoring modes for the status elements may include a “registered” status wherein the status elements are authorized and compatible with the gateway device; a “discovered” status wherein the status element is installed but not activated to communicate with the management system; an “activated” status wherein the status elements are associated with a specific circuit protector and communicating with the management system; a “suspended” status wherein the status element has been caused not to function; a “deactivated” status wherein the element is uninstalled and not associated with any circuit protector; or an “offline” status wherein the status element is activated but not reporting to the management system 112. The signal transmission components, including but not limited to the repeater/router elements 582, may likewise be designated and identified by the management system.

Additional characterization, grouping, or labels of the status elements for the circuit protectors may be provided for informational purposes to provide an overview of the entire management system and status of the monitoring and signal transmission components as the system is expanded, contracted, or changed in use, and as more electrical loads or configuration of the electrical system are changed or adapted over time. The operating modes may be automatically detected by the gateway device 584, or may be manually entered by installers, technicians, and service personnel for the status elements. The gateway device 584 may therefore intelligently manage the addition or subtraction of circuit protector status elements and repeater/router elements 582 to and from the circuit protector management system 112.

Timestamp alert algorithms 598 and associated displays may also be included in the application software 590 for inspection and maintenance purposes wherein the communications systems between the status elements, the repeater/router elements 582 and the gateway device 584 are periodically verified to ensure operation of the monitoring and communication components in the circuit protector management system 112. As one example, the circuit protector status elements and/or the repeater/router elements 582 may be programmed to communicate or report with the gateway device 584 on a periodic basis or interval, sometimes referred to as a watchdog interval, and the gateway device 584, through the application software 590, could monitor the operating status or health of the management system by comparing signals received from the status elements and the repeater/router elements with information entered into the system, via the configuration and monitoring algorithms and displays 592, of the status elements and repeater/router elements known to be in the circuit protector management system 112. If, for example, one of the repeater/router elements 582 or one of the circuit protector status elements does not report in a predetermined time frame, an error flag may be set and alert may be generated to the installer/site technician 594, either directly from the gateway device 584 or indirectly through the overview and response dispatch system 118. The timestamp alert algorithms 598 and the configuration and monitoring algorithms 592 may then be accessed by site technicians 594 to diagnose and troubleshoot the circuit protector management system 112.

Data reduction algorithms 600 may be included in the application software 590 for processing signal transmissions from the repeater/router elements 582 before communicating with the overview and response dispatch system 118. For example, the gateway device 584 may filter incoming data signals and identify duplicate signal transmissions that may occur, for example, when more than one of the repeater/router elements 582 transmits the same signal to the gateway device, or as another example, when the same status element signals the repeater/router elements 582 more than once to avoid for example, collision of data signals. Duplicate signals may be discarded or deleted by the gateway device 584 prior to communicating signals to the overview and response dispatch system 118.

The data reduction algorithms 600 may also reduce or eliminate information from the data signals that are not necessary for the overview and response dispatch system 118 functionality. For example, messaging protocol information pertinent to the radio frequency transmission of the data signals but not pertinent to the network messaging protocol for communication with the overview and response dispatch system 118, may be stripped, eliminated, or deleted from the data signals before transmission to the overview and response dispatch system 118.

Data logging algorithms 602 and associated displays may also be included in the gateway application software 590 for supplying and receiving information and data and generating reports of management system activity. Such information and reports, as explained above, could be a useful tool for proactive management of an electrical system to identify issues in the electrical system that may cause operation of one or more circuit protectors to isolate portions of the circuitry, and perhaps allow for technicians 594 to take steps to control and manage the electrical system in a way that opening of the circuit protectors is avoided altogether, which is especially advantageous in critical applications, such an electrical system for a hospital.

The data logging algorithms 602 and displays could also be used to initiate special procedures responsive to real time operation of the electrical system, such as shutting down certain machines or portions of the circuitry at high risk when one or more of the circuit protectors operates. Such procedures may be particularly appropriate, for example, when one phase of a three phase electrical power supply becomes isolated or interrupted due to an operated circuit protector, and a machine or load is temporarily powered by only two phases of electrical current.

Each of the configuration and monitoring algorithms 592, the timestamp alert algorithms 598, the data reduction algorithms 600 and the data logging algorithms 602 are interconnected with a database 604 or memory storage medium needed to store inputted, collected, and received data, operating parameters and settings, and the machine readable operating software codes and algorithms, etc. that the gateway device 584 may require.

A communications interface 606, a communications driver 608, and interface drivers 610 may also be provided in the gateway application software 590 to provide communication between operative components in the circuit protector management system 112.

The gateway device 584 may also perform authentication, verification, or security algorithms to ensure the integrity of the management system communications, as well as perform diagnostic, testing, and troubleshooting procedures to ensure proper installation and operation of the circuit protector status elements and repeater/router elements 582 in the overall circuit protector management system 112.

In an exemplary embodiment, a portal monitoring and communications application 612 may be provided for further processing of data signals to convey information to the overview and response dispatch system 118. The communications application 612 may include protocol algorithms 614 to convert message data from the incoming radio frequency data transmission protocol, for example, to a preferred network messaging protocol, including but not limited to HTTPS, SOAP, and XML protocols and their equivalents known in the art, and internet protocol algorithms 616 for transmitting the network messaging protocol data packets to the remote overview and response dispatch system 118 via, for example, an Ethernet connection 618.

In an exemplary embodiment, the incoming radio frequency data protocol is a byte oriented protocol having multiple bits representative of information of interest. For example, the status elements may transmit digital data signals including bits corresponding to a unique radio identifier, a manufacturer serial number for the status element, a device type code for the circuit protector, a location or address code for the circuit protector, a power/control code, an equipment identification code, and state parameter codes such as testing codes, faults codes, and codes pertaining to operating conditions of the circuit protector and/or circuitry associated with the status elements. The data signals may also include codes relating to the ambient environment of the circuit protector or the associated electrical system and loads, such as temperature codes, vibration codes, displacement codes, mechanical stress codes, mechanical strain codes, acoustical emission codes, noise codes, thermal imagery codes, electrical resistance codes, pressure codes, humidity codes and video surveillance codes.

The repeater/router elements 582 may add bits to the signal protocol corresponding to a serial number of the respective repeater/router element, a device type code for the repeater/router, a wireless address for the repeater/router, a data packet sequence number, a location code for the repeater/router, and state parameters pertaining to operating conditions of the repeater/router elements.

The gateway device 584 converts the radio frequency transmission protocol to a second, and different messaging protocol for transmission to the overview and response dispatch system 118. The second message protocol may also be byte oriented and include bits corresponding to the unique radio identifier, a serial number of an operated circuit protector, a device type code for the operated circuit protector, a location code for the operated circuit protector, a wireless address, an IP address for the gateway device, a time/date stamp, a software revision code for the gateway application software and/or the communications application loaded on the gateway device, a hardware revision code for the gateway device, a packet count, an error count, and a predetermined number of error codes. When received by the overview and response dispatch system 118, the gateway data message can be used to quickly determine operation of the circuit protectors, locate operated circuit protectors in the electrical system, and notify and summon responsible personnel and technicians for quickly re-energizing downed circuitry. Furthermore, all of the codes and data relating to signal events in the system are logged for future use, retrieval, study and analysis to evaluate the performance of the overall circuit protector management system 112.

While some exemplary message codes have been described, it is understood that other types of codes, information and data representative of circuit protector products and operating status may be included in alternative embodiments, and it is also recognized that less than all of the exemplary protocol bits and codes could be used in other embodiments of the signal transmission system 580. Implementation of the message protocols may be conventionally provided and is not specifically described in further detail herein.

The gateway application software 590 and the communications application 612 may run on a known operating system 620 loaded on the gateway device 584, including but not limited to Windows, PocketPC, and Linux operating systems and their equivalents known in the industry. Having now described the various operating algorithms functionally, programming of the modules to operate in the manner described may be conventionally provided by those in the programming arts without further explanation.

In an exemplary installation, the gateway device 584 may be located at the electrical system site, and the overview and response dispatch system 118 may be located remotely, although the overview and response dispatch system 118 could be located at the site of the electrical system as well.

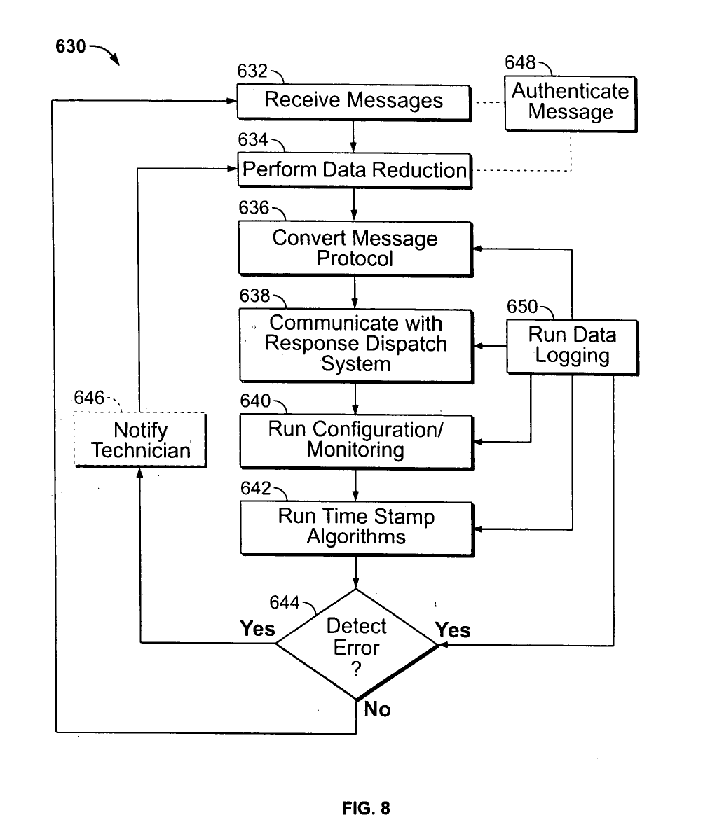

FIG. 8 is a flowchart of a method 630 executable by the gateway device 584 in an exemplary embodiment. The gateway device 584 awaits signals from the repeater/router elements, and receives the signals 632 in any manner described above. Data reduction is performed 634 on the incoming signals in the manner described above, and the incoming message protocol is converted 636 to a second message protocol, different from the incoming message protocol. Once the message protocol is converted 636, the gateway device communicates 638 the converted data message to the remote overview and response dispatch system 118 for action or attention in the manner described above.

As appropriate or as needed, the gateway device runs 640 the configuration and monitoring algorithms and runs 642 the timestamp algorithms as described above. If an error is detected 644, the gateway device may notify 646 a technician and perform data reduction procedures 634 to prepare to send an error signal to the overview and response dispatch system. If an error is not detected 644 during the time stamp algorithms and procedures, the gateway devices reverts to a dwell state until another message is received 632 from the repeater/router elements.

Optionally, incoming messages may be authenticated 648 or other verification and security algorithms and procedures may be implemented to ensure the integrity of the system communications. Data logging procedures are run 650 as needed during operation of the gateway device 584, and data may be accessible by or be communicated to the remote overview and response dispatch system as desired.

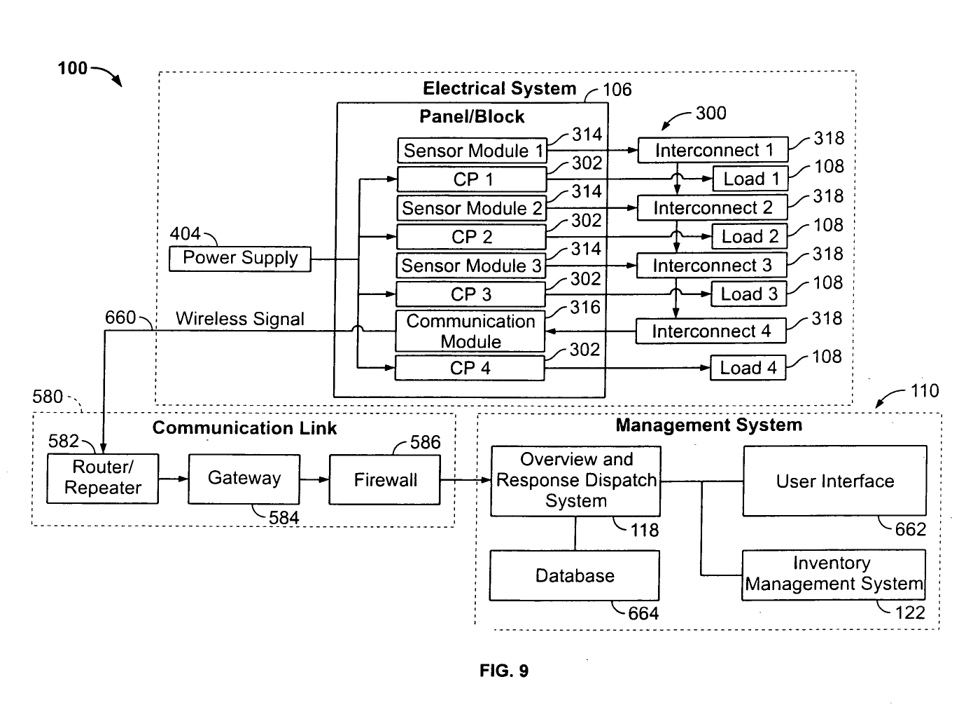

FIG. 9 schematically illustrates the signal transmission system 580 connected to an electrical system 100 and the management system 112. The electrical system 100 includes a power supply or power supply circuitry 102 connected to multiple circuit protectors such as fuses 302 in a circuit protector panel 104. Each of the fuses 302 is associated with a sensor module 314 or a communications module 316, and each of the fuses 302 is connected to an electrical load 106. The interface plugs 318 interconnect the sensor modules 314 to one another and to the communications module 316 in the manner described above. Due to the interconnection of the modules 314, 316, when any of the fuses 302 operates to isolate any of the loads 106, a data packet is presented to the transmitter 340 of the communications module 316, and a wireless signal 660 is transmitted by the communications module 316. The wireless signal 660 is received and forwarded by at least one of the repeater/router elements 582 to the gateway device 584. The gateway device 584, protected by a firewall 586, then communicates the information to the overview and response dispatch system 118.

The management system 112 includes the overview and response dispatch system 118, a user interface or display 662 connected to the overview and response dispatch system 118, and may be in communication with the inventory management system 120 for automatic ordering of replacement fuses. A memory or database 664 may also be provided to log system activity and store needed information for the overview and response dispatch system. For example, the database 664 may be used to decode incoming data packet transmissions from the gateway device 584, and the user interface 662 may be used to present information to responsible personnel in tabular and graphic form with menu-driven displays described below. The database 664 may also be used for storage and retrieval of contact information for locating and summoning maintenance personnel.

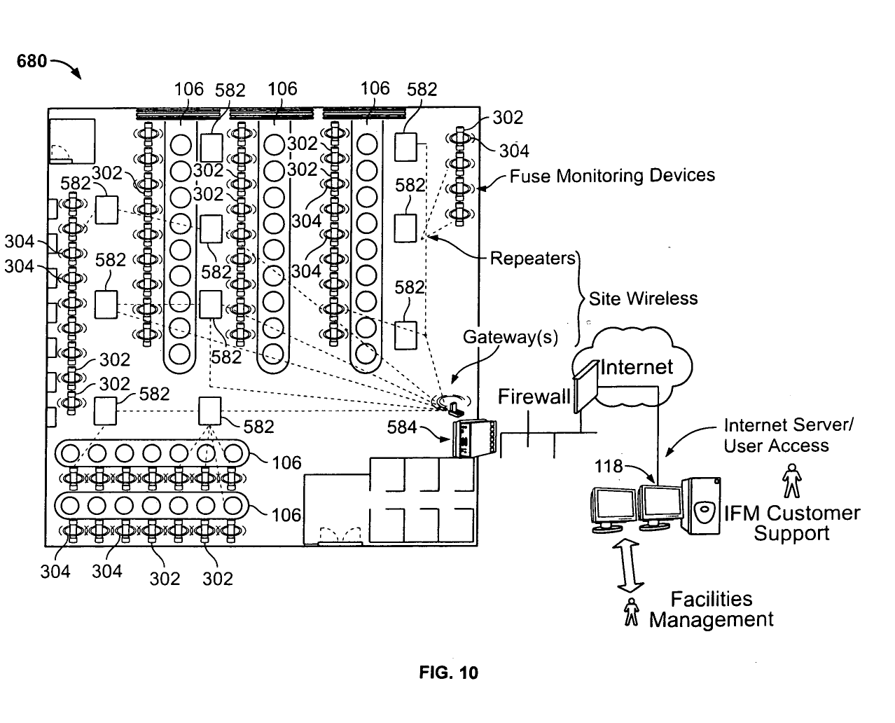

FIG. 10 is an exemplary site diagram of an electrical facility 680 housing an electrical system having many circuit protectors 302 to be monitored in various panels 104 in the facility 680. Monitoring modules 304, some of which are communication modules 316 and some of which are sensor modules 314 are associated with circuit protectors such as fuses 302 scattered throughout the facility 680. A number of repeater/router elements 582 are also strategically located in different locations in the facility 680 within the operating range of the monitoring modules 304, and specifically the communications modules 316. The repeater/router elements 582, in turn, are in communication with a centralized gateway device 584 that communicates with the overview and response dispatch system 118 at a remote location via, for example, the Internet.

As FIG. 10 demonstrates, the management system can efficiently monitor a large number of fuses 302, and as the size and complexity of the facility 680 increases, the system is readily adaptable by adding additional monitoring modules 304 and repeater/router elements 582. The overview and response dispatch system 118 directly interacts with facilities management to provide real time system performance data and immediate information so that downed circuitry may be re-energized as quickly as possible.

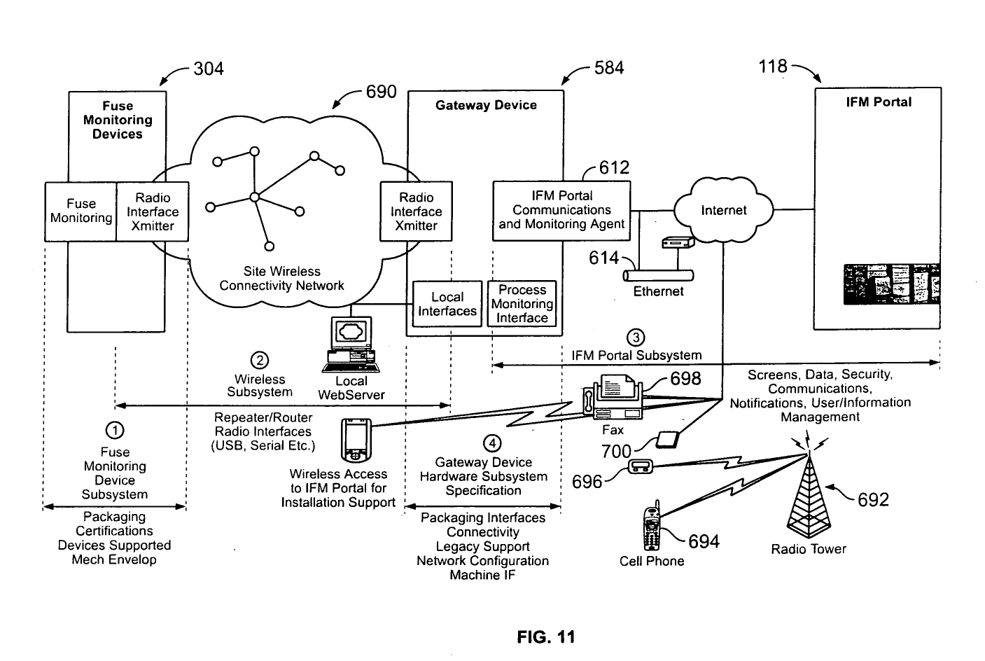

FIG. 11 further illustrates additional features of the management system shown in FIGS. 9 and 10 in one implementation thereof. The fuse monitoring modules 304 are interfaced with a network 690 of repeater/router elements 582 that are, in turn, interfaced with the gateway device 584. The gateway device 584 may be connected to local network interfaces and process monitoring interfaces of, for example, the facility 680. The portal communications application 612 of the gateway device 584, implemented in software or machine readable code, processes incoming signals from the repeater/router network 690. After processing by the portal communications application 612, the gateway device 584 communicates with the Internet via an Ethernet connection 618 and ultimately with the overview and response dispatch system 118. In response to communications from the gateway device 584, the overview and response dispatch system 118 communicates with responsible personnel for the electrical system through the Internet and communication towers 692, for example to contact designated personnel by phone 694, pager 696, facsimile 698, email 700, or via a customer web site to provide direction and information regarding operated circuit protectors and re-energizing circuitry.

E. An Alternative Monitoring Module and Signal Transmission System.

While the embodiments of monitoring modules and signal transmission systems above may be effective to resolve difficult problems in electrical systems relating to efficiently identifying operated circuit protectors to restore affected circuitry, it is recognized that the aforementioned benefits and advantages may be achieved apart from the monitoring modules and signal transmission system described in detail above.

One potential drawback to the system described above lies in the fact that it requires installation of a signal transmission system, such as the system 580 illustrated in FIG. 6, in and around the electrical system to be monitored. Especially for systems having a large number of circuit protectors to be monitored, hardware and software costs for the requisite repeater/router elements 582 and gateway devices 584 to manage signal transmissions can accumulate quickly.

One way to reduce costs in implementing the management system would be to utilize an existing communications network already operating at the site of the electrical system to transmit data and information relating to the operating states of circuit protectors as opened or interrupted and not carrying current, or unopened in a normal current carrying state. Cellular communication networks, for example, are in wide use in ever-expanding geographic areas around the world, and many electrical systems are located in the presence of an operating cellular network. Where circuit protectors in an electrical system are located within signal range of a cellular communication tower, transmission of circuit protector data and information over existing cellular communication networks may be an attractive option.

A cellular communication network is a radio network including a number of radio cells that are each served by a fixed transmitter, often located on a transmission tower and sometimes referred to as a cell cite or a base station. The cells provide coverage over different geographic areas, so that in combination the cells provide radio coverage greater than any one of the cells. The cells are typically sized at about 10 square miles and are often diagrammed as hexagons on a hexagonal grid. Such cellular communication networks are principally used by cellular phone users and users of other mobile devices who may be physically located in a practically unlimited number of positions within the cells, and the communication networks are configured so that users may roam between cellular communication networks of different providers without interruption of communication services.

Unlike the signal transmission system 580 (FIG. 6) wherein communication occurs at a designated and generally fixed frequency, a cellular communications network operates on a large number of frequencies, such as 832 possible frequencies typically licensed for use, of which 395 of the frequencies are reserved for full duplex voice channels and of which 42 frequencies are used for data and control channels. Significantly, the frequencies in a cellular transmission network may be reused in non-adjacent cells in the network, allowing simultaneous use of the network by a large number of users. In heavily populated areas, hundreds of cellular transmission towers may be present, but because of the large number of users, costs per user may be relatively low. Each cell site typically has a range of 0.25 to 20 or more miles, and the cells are typically arranged to overlap one another.

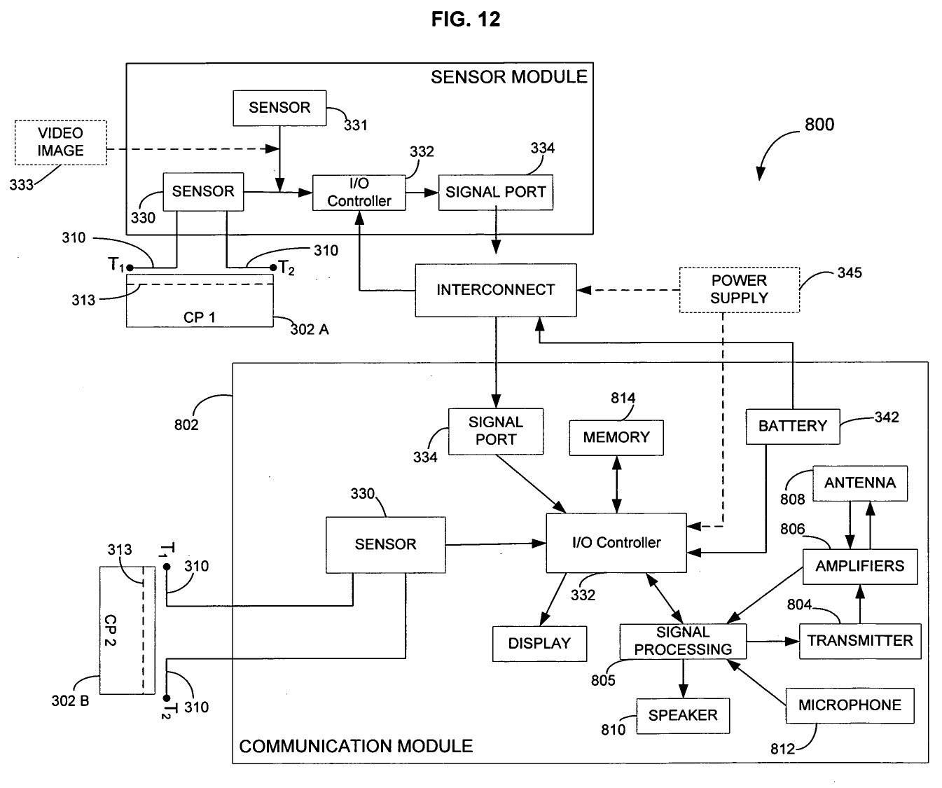

FIG. 12 is a schematic block diagram of an embodiment of a monitoring assembly 800 for the system shown in FIG. 1. The monitoring assembly 800 may be used in lieu of or in addition to the monitoring assembly 300 shown in FIGS. 3 and 4. Because the monitoring assembly 800 is similar in some aspects to the monitoring assembly 300, like reference characters of the assembly 300 are utilized in FIG. 12 to indicate like components.

The monitoring assembly 800 includes a sensor module 314 and a communication module 802. Like the assembly 300, each sensor module 314 includes a sensor 330, an input/output element 332 connected to the sensor 330, and a signal port 334. The sensor 330 is connected to the contact arms 310 that are connected to the terminal elements T₁ and T₂ of, for example, a circuit protector fuse 302A, such an overcurrent protection fuse. The sensor 330 may be, for example, a voltage sensing latch circuit having first and second portions optically isolated from one another. When the primary fuse element 313 of the fuse 302A opens to interrupt the current path through the fuse 302A, the sensor 330 detects the voltage drop across the terminal elements T₁ and T₂ of the fuse 302A. The voltage drop causes one of the circuit portions, for example, to latch high and provide an input signal to the input/output element 332.

One or more additional sensors or transducers 331 may be provided, internal or external to the sensor module 314, to collect data of interest with respect to the electrical system and the load connected to the fuse 302A. For example, sensors or transducers 331 may be adapted to monitor and sense vibration and displacement conditions, mechanical stress and strain conditions, acoustical emissions and noise conditions, thermal imagery and thermalography states, electrical resistance, pressure conditions, and humidity conditions in the vicinity of the fuse 302A and connected loads. The sensors or transducers 331 may be coupled to the input/output device 332 as signal inputs. Video imaging and surveillance devices 333 may also be provided to supply video data and inputs to the input/output element 332.

In an exemplary embodiment, the input/output element 332 may be a microcontroller having a microprocessor or equivalent electronic package that receives the input signal from the sensor 330 when the fuse 302A has operated to interrupt the current path through the fuse 302A. The input/output element 332, in response to the input signal from the sensor 330, generates a data packet and outputs the data packet to the signal port 334. The data packet may be formatted in any desirable protocol, but in an exemplary embodiment includes at least an identification code, a fault code, and a location or address code in the data packet so that the operated fuse may be readily identified and its status confirmed, together with its location in the electrical system. Of course, the data packet could contain other information and codes of interest, including but not limited to system test codes, data collection codes, security codes and the like that is desirable or advantageous in the communications protocol.

Additionally, signal inputs from the sensor or transducer 331 may be input to the input/output element 332, and the input/output element 332 may generate a data packet in a predetermined message protocol and output the data packet to the signal port 334. The data packet may include, for example, codes relating to vibration and displacement conditions, mechanical stress and strain conditions, acoustical emissions and noise conditions, thermal imagery and thermalography states, electrical resistance, pressure conditions, and humidity conditions in the vicinity of the fuse 302A and connected loads. Video and imaging data, supplied by the imaging and surveillance devices 333 may also be provided in the data packet.

The communications module 802 in an exemplary embodiment may also include a sensor 330, an input/output element 332 such as a microprocessor, and a signal port 334. Like the sensor module 314, the sensor 330 of the communications module 802 is connected to the contact arms 310 that are connected to the terminal elements T₁ and T₂ of one a circuit protector fuse 302B, and the sensor 330 of the communications module 316 operates substantially in the same manner as described above to sense an operating state of a primary fuse element 313 in the fuse 302B. However, when the sensor 330 detects operation of the fuse 302B, the input/output element 332 generates and outputs a corresponding data signal to a transmitter 804 that communicates with the overview and response dispatch system 118 via a cellular communications network as described below.

In one embodiment, the transmitter 804 is a low power radio transmitter, typically 0.6 watt to 3 watt transmitters that communicate wirelessly with the cellular communications network. Point-to-point wiring in the electrical system for fuse monitoring systems is therefore avoided.

Like a cellular phone, the communications module 802 may include a signal processor 805 coupled to the transmitter 804, one or more amplifiers 806 and an antenna 808 for sending signals to the cellular communication network. Likewise, signals from the cellular communication network may be received via the antenna 808 and passed through one or more amplifiers 806 to the signal processor 805. The signal processor 805 may include analog-to-digital converters, digital-to-analog converters and the like for communication with various types of cellular communication networks. A speaker 810 and microphone 812 may be provided in communication with the signal processor. A memory 814 may be coupled to the input/output element 332, and the memory 814 may be a read only memory (ROM) chip or a flash memory chip, for example. The communications module 802 may be assigned a phone number and may be capable of making and receiving calls over the cellular communication network to report circuit protector status and to receive status inquiries.

The memory 814, in addition to operating algorithms and control functions for the module 802 and data storage for circuit conditions obtained through the sensors 330 and 331, may include phone numbers and contact information for designated persons, and a recorded voice message. The voice message may be programmed into the module 802 or input to the memory 814 with the microphone 812 at the time of installation. The voice message may include a verbal description or announcement including data that may be broadcast over the cellular communication network to responsible personnel for operating an electrical system. That is, the module 802 may directly communicate with responsible personnel by calling, for example, cellular phones of specific persons. Voice announcements and audio alarms may also be played through the speaker 810 for identification purposes in locating specific modules in an electrical system. That is, a technician may be able to more quickly locate an operated circuit protector in the electrical system by listening for the announcement or the audio alarm.

Also in accordance with the methodology shown in FIG. 2, the communications module 802 may also await acknowledgement of persons contacted via return phone calls, escalate alarm notifications if not promptly acknowledged, initiate special procedures, and initiate a replacement order for a replacement circuit breaker if desired. Multiple and different voice messages may be provided and utilized by the communications module for specific purposes. That is, for example, an escalated alarm announcement may be worded differently than an initial report, and initiation of special procedures and initiation of replacement orders may require different information and description than do alarm and notification announcements. Established Interactive Voice Response (IVR) technology may be built-in to the communication modules 802 and/or the management system to allow responders to circuit protector operating events and technicians and maintenance persons to interact with the monitoring system using simple voice commands and voice activated menu selections to obtain circuit protector status, sensed circuit conditions, location instructions, replacement instructions, instructions relating to personal protective equipment required to safely service the circuit protector, and other information of interest.

By way of example, an announcement may include a call back number for the communication module 802, a unique radio identifier, a manufacturer serial number for the communications module 802, a device type code for the circuit protector 302B or the circuit protector 302A for the attached sensor module 314, a location or address code for the circuit protector 302A or 302B, a power/control code, an equipment identification code, a testing code, a fault code, a customer code, a temperature code, a vibration code, a displacement code, a mechanical stress code, a mechanical strain code, an acoustical emission code, a noise code, a thermal imagery code, an electrical resistance code, a pressure code, a humidity code and a video code.

In addition to verbal voice messages including data and information relating to the circuit protector and the communication module 802, the memory 814 may also include digitized data and information relating to communications module 802 and the associated circuit protector 302B that may also be communicated electronically to the remote overview and response dispatch system 118 via the cellular communications network. Also, an array of functionality that has been established for cellular phone users may be incorporated and may be utilized by the communications module 802 to advise and summon responsible personnel when a circuit protector operates in an electrical system, including paging functions, facsimile transmission, text messaging, email, web browsing, and multimedia file transfer including audio and video files. The overview and response dispatch system 118 may also be programmed to generate alerts and notifications to specific persons by various means independent from the communications module 802, and as well as to electronically archive and document reported circuit protector events and histories of the electrical system that may be used for diagnosis and troubleshooting purposes.

In accordance with known cellular technologies, access to the cellular communications network for the communications module 802 may be established with an electronic serial number (ESN) that is programmed into the module 802, a mobile identification number (MIN) that is a unique number assigned to the communications module and derived from a phone number for the module 802, and a system identification code (SID) that is assigned to an authorized cellular network carrier. Using the ESN, MIN and SID the module 802 may communicate with a mobile telephone switching office (MTSO) that controls the cellular base stations in the network.

Various communication access method technologies are known, both digital and analog, that may be utilized to facilitate communication between the module 802 and the cellular communication network, including frequency division multiple access (FDMA), time division multiple access (TDMA) code division multiple access (CDMA), and Personal Communication Services (PCS) that are based in part on the TDMA system. Global System for Mobile communications (GSM) technology is also widely available, and is the basis for a popular access system known as the Integrated Digital Enhanced Network (IDEN). Analog cellular service is also available and is known as the Advanced Mobile Phone System (AMPS), and the Narrowband Advanced Mobile Phone Service Systems (NAMPS) incorporates some digital technology into the AMPS system. So-called Smartphone technology allowing for increased bandwidth and transfer rates for multimedia cell phones is under development and is emerging in the marketplace. Any of these access technologies, and equivalent technologies, may be utilized to facilitate communication over a cellular network. All the foregoing types of service are currently in use in different geographic areas around the world, and the specific type of access technology utilized in any given installation of the communications module 802 is dependent upon the local cellular network and which type or types of service it will support.

In one embodiment, the communications module 802 may include multiple band capability that allows communication, for example, at 800 MHz or 1900 MHz in a TDMA system. The communications module 802 may also have multiple mode technology and may capably detect and switch itself between different types of access technologies such as an AMPS system and a TDMA system. When provided with multiple band and multiple mode capability, the communications module 802 may capably determine the appropriate mode and type of cellular network and automatically select the band and mode for substantially universal use with different types of systems. In other embodiments, however, the monitoring modules 802 could be provided to communicate with specific bands and modes utilized by the particular local cellular network at the point of installation.

The communications module 316 may further include an on-board battery power supply 342 that powers the electronic sensor 330 and/or the input/output element 332 and associated components in the communications module 802. The battery 342 may also supply power, through the interface plugs 318, to the input/output element 332 and/or the sensor 330 of the communications module 316. Thus, multiple sensor modules 314 may be powered by a single communications module 802 to monitor a plurality of fuses 302.

The battery 342 may be replaceable as needed to extend the life of the monitoring assembly 800. A test button (not shown in FIG. 12) may be provided in the communications module 316 to ensure that the battery 342 is powered and the module electronics in the communications module 802 and connected sensor modules 314 are working properly. Reset buttons may also be provided in the modules for testing and diagnostic purposes. A power harvesting device such as rechargeable batteries and the like that store energy when not in use may be utilized in addition to or in lieu of the battery 342. A backup power supply 345, or other circuits of the electrical system may also be used to power the sensor and communications modules 314, 802. Energy storage components such as capacitors may also be employed, and switching devices may be provided to switch between energy storage elements, power harvesting devices, batteries, and backup power supplies, or other circuitry to power communications after circuit protector 302A has operated.

Also, the signal port 334 of the sensor module 314 may communicate, via the interface plug 318 with the signal port 334 of the communications module 802. Thus, the sensor module input/output element 332 may generate a data packet that is sent to the sensor module signal port 334 through the interface plug 318 and to the communications module input/output element 332 for transmission via the transmitter 804. Thus, signals are simply passed through the respective signal ports 334 via the interface plug 318, and multiple sensor modules 314 may be connected to a single communications module 802 via interconnecting the interface plugs 318 to the signal ports 334. In such a manner, the number of communication modules 802 and transmitters 804 in the circuit protector management system may be reduced, together with associated costs and maintenance issues.

Additionally, status indicators and the like such as light emitting diodes (LED's) may be provided in the sensor and communication modules 314, 802 to locally indicate an operated fuse 302. Thus, when maintenance personnel arrive at the location of the operated fuse 302, the status indicators may visually identify an operated fuse 302 and provide local state identification of the fuses associated with the modules 314, 802.

Like the assembly 300 described above, the modules 314 and 802 may be provided in modular form wherein different sized mounting clips and differently dimensioned contact arms 310 to accommodate fuses of varying sizes and configurations. By providing various mounting clips and mounting structure, together with various contact arms and contact structure to establish electrical contact with the fuses, the modules 314 and 802 are readily adaptable to accommodate most if, not all, types of fuses, and the modules 314 and 802 may be retrofitted to complex electrical systems with snap-on engagement, thereby minimizing installation time and complexity in existing electrical systems.

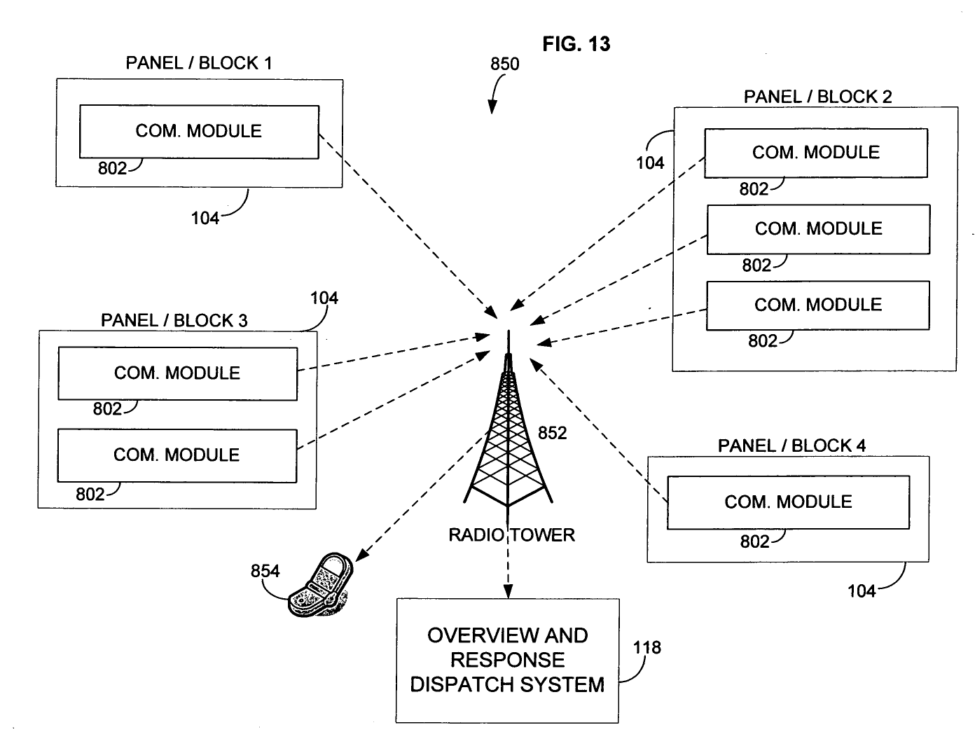

FIG. 13 is a schematic block diagram of a networked circuit protection signal transmission system 850 that may be used with monitoring assemblies 800 such as those shown in FIG. 12. A plurality of circuit protector panels 104 are distributed throughout the electrical system, and each circuit protector panel 104 in the electrical system that is to be monitored includes, for example, a monitoring assembly 800 for transmitting, whether in voice messages or digitized data messages, information and data corresponding to the operational state one or more circuit protectors, such as fuses, in the panels 104. In the manner described above, the communications modules 802 wirelessly connect with and communicate with a transmission tower 852 of the cellular communications network when one of the fuses associated with the monitoring assemblies 800 opens.

The communication modules 802 are located within the signal range of the transmission tower 852. The tower 852 is typically a steel pole or lattice structure that may rise hundreds of feet into the air for unobstructed transmission, and consequently the transmission tower 852 would not ordinarily be on-site for many electrical systems. The tower 852 is typically operated and controlled by one or more licensed carriers of cellular services, and would not typically be managed by the operators of the electrical systems to be monitored. More than one tower 852 may be located in signal range of the communication modules 802, and the transmission tower 852 may include switching gear and other components that outfit the tower 852 as a cellular base station. Using any of the aforementioned access technologies, the communication modules 802 may communicate with the tower 852 and ultimately, for example, with a cellular communication device 854 of a person to be contacted for open fuse events, and with the electronic overview and response dispatch system 118, which may include a cellular modem and the like to facilitate communication over the cellular network.

Depending on the power of the transmitter and the signal strength of the tower 852 at the point of installation of a monitoring assembly 800, the communication modules 802 may communicate with the tower through walls and building materials, and other obstructions that would otherwise prevent line-of-sight communication between the modules 802 and the tower 852. Especially for electrical facilities located indoors in an industrial facility, for example, the ability of the modules 802 to communicate with the tower 852 outside the facility will in part be affected by the type of cellular service available and the power of the transmitters in the communication modules 802. Due consideration of noise and interference issues in the ambient environment should also be taken into account when determining an optimal configuration of the communication modules 802 for a particular type or mode of cellular service. When more than one cellular service provider is available, such considerations may render one provider's service more desirable than another's.

It is also contemplated that the cost of subscribing for cellular service by a particular provider may be influential, particularly as the number of communication modules 802 increases in the electrical system being monitored. In one embodiment, the communication modules 802 may be programmed to communicate infrequently over the communication network and expected usage time for the network would be relatively low for each communication module, leading to potential cost savings. Indeed, some circuit protectors may not operate for years or even decades after they are installed, and if the communication modules 802 communicate only when the circuit protectors operate to open portions of the circuitry, the modules will not use any air time on a regular basis. A pre-paid communications package allowing for a predetermined usage time, such as ten minutes, may be appropriate in such an embodiment. In other embodiments, the communication modules 802 may be programmed to report on more regular intervals regardless of whether or not the circuit protectors have operated, but it is still envisioned that communications may be made quickly and that an economical cellular service arrangement could be structured accordingly.

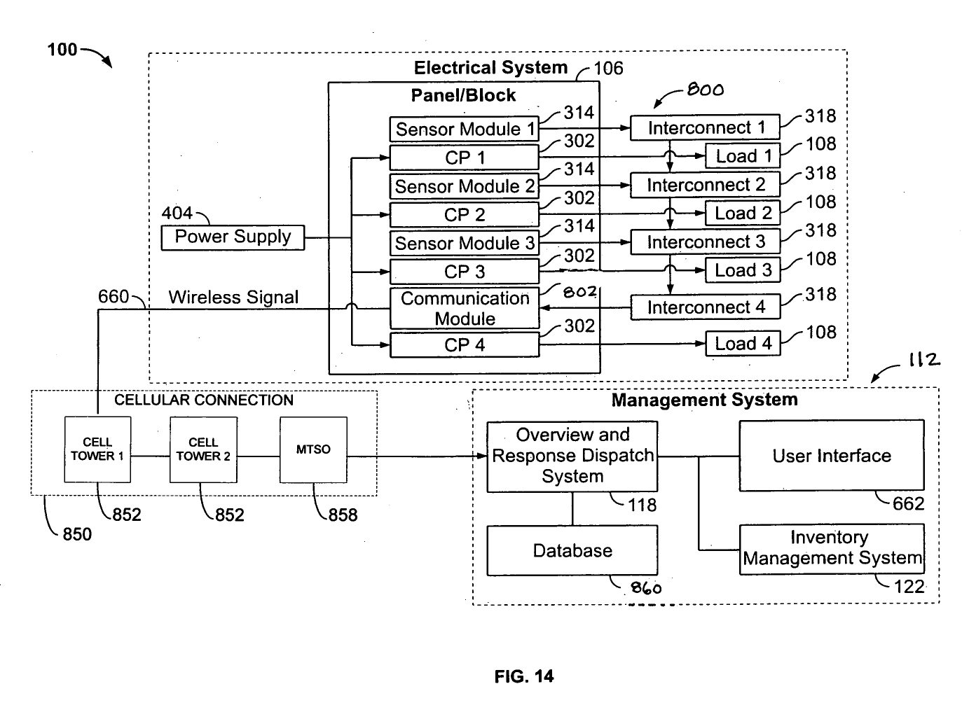

FIG. 14 is a schematic block diagram of the monitoring assembly 800 connected to an electrical system and in communication with a management system 112 utilizing the signal transmission system 850 in FIG. 13.

The electrical system 100 includes a power supply or power supply circuitry 102 connected to multiple circuit protectors such as fuses 302 in a circuit protector panel 104. Each of the fuses 302 is associated with a sensor module 314 or a communications module 802, and each of the fuses 302 is connected to an electrical load 106. The interface plugs 318 interconnect the sensor modules 314 to one another and to the communications module 802 in the manner described above. Due to the interconnection of the modules 314 and 802, when any of the fuses 302 operates to isolate any of the loads 106, the communications module 802 connects to the cellular network 850 and presets a voice message or digitized data message to the management system 112, and specifically to the overview and response dispatch system 118.

The cellular network 850 may include one or more transmission towers 852 in signal range with one another, one of which is typically a base station, and a Mobile Telephone Switching Office (MTSO) 858 that provides, among other things, the ability to connect to public telephone networks and land lines, or to another switch of the telephone company, to transmit calls to appropriate locations, including a remotely located management system 112.

The management system 112 may include the overview and response dispatch system 118, a user interface or display 662 connected to the overview and response dispatch system 118, and may be in communication with the inventory management system 120 for automatic ordering of replacement fuses. A memory or database 860 may also be provided to log system activity and store needed information for the overview and response dispatch system. Data and information relating to circuit conditions and circuit protector interruption events may be presented to responsible personnel in tabular and graphic form with menu-driven displays. The database 860 may also be used for storage and retrieval of contact information for locating and summoning maintenance personnel.

The advantages and benefits of implementing such a fuse monitoring system using existing cellular communication systems are many. Potential cost savings associated with hardware and software to establish a separate communications network on the site of the electrical system to be monitored are presented, including for example, the cost of repeater/router elements and gateway devices to manage signal transmissions that are not necessary to communicate data and information to other locations. A full range of functionality and features available in cell phone devices may be readily harnessed in the communication modules 802 using cellular communication networks, many of which may otherwise be difficult and more expensive to provide using non-cellular communication networks. Software updates and revisions may be simply downloaded over the cellular network in a similar fashion to known cellular devices. An ability to call a specific communications module and inquire of the status of an individual circuit protector is present. A continued investment in cellular device technology is bound to produce additional features and benefits that may be desirable in the fuse monitoring system.

F. Conclusion

The systems and processes described above are not limited to the specific embodiments described herein. Components of each system and each process can be practiced independent and separate from other components and processes described herein. Each component and process also can be used in combination with other components, systems and processes.

For example, while the communication modules 802 are described as being adapted for retrofit installation to existing circuit protectors, the functionality of the communication modules 802 could alternatively be built-in to circuit protector panels or other infrastructure, or into the circuit protectors themselves in other embodiments. Also, while the sensor and communication modules are described and illustrated for use with fuses, other types of circuit protectors providing overvoltage, overcurrent, overload, and short circuit protection, for example, may be monitored with appropriate modification of the modules.

Also, the foregoing circuit protector communication modules 802 and the monitoring and management system 112 may be implemented in whole or in part to meet the needs of a particular electrical system 100 or for cost management reasons. In other words, the communication modules 802 and the management system 112 need not include all of the described components, or perform all of the described functions set forth above.

As still another example, the communication modules 802 and the management system 112 could identify and determine operational status and data regarding the circuit protector and circuitry and communicate and transmit data to the overview and response dispatch system 118, but not communicate with an inventory management system.

It should now be apparent that the system components may be mixed and matched to generate varying systems which obtain the benefits of the present invention to varying degrees.

An embodiment of a circuit protector signal transmission system for at least one circuit protector defining an interruptible current path therethrough upon an occurrence of specified operating conditions in a circuit is disclosed herein. The system comprises a status element associated with the circuit protector and adapted to monitor an operating state of the current path; and a transmitter configured to communicate the operating state of the current path over a cellular communications network.

Optionally, the status element may transmit a voice message over the cellular communication network, with the voice message including operating state information for the circuit protector. The status element may transmit a data signal over the cellular communication network, with the data signal corresponding to the operating condition of the current path, and the data signal comprising at least one of a unique radio identifier, a manufacturer serial number for the status element, a device type code for the circuit protector, a location or address code for the circuit protector, a power/control code, an equipment identification code, a testing code, a fault code, a customer code, a temperature code, a vibration code, a displacement code, a mechanical stress code, a mechanical strain code, an acoustical emission code, a noise code, a thermal imagery code, an electrical resistance code, a pressure code, a humidity code and a video code.

Also optionally, the cellular communication network may comprise a digital cellular communications network. An electronic overview and response dispatch system may be in communication with the cellular communications network, wherein the response dispatch system is responsive to communication from the status element to automatically alert and summon responsible personnel when the circuit protector has operated to open the circuit path. The electronic overview and response dispatch system may be configured to identify the location of the operated circuit protector to the responsible personnel. The status element may comprise a monitoring module that may be retrofit to a circuit protector. The status element may also comprise a speaker, with the speaker providing an audio alarm when the circuit path has been interrupted. Further, the status element may comprise a microphone for recording a voice message including an identifier for the circuit protector and the location of the circuit protector. The status element may be configured for multi-band and multiple mode communication on the cellular communications network.

Another embodiment of a signal transmission system for a plurality of circuit protectors is also disclosed. Each of the circuit protectors defines an interruptible current path therethrough upon an occurrence of specified current conditions through the interruptible current path. The system comprises a status element associated with at least one of the circuit protectors, the status element being adapted to monitor an operating state of at least one of the respective current paths, the status element adapted to connect with and communicate over a cellular communications network when one or more of the current paths are interrupted as the circuit protectors operate.

Optionally, the plurality of circuit protectors may be fuses, with the status element transmitting data related to operation of the fuses, and the data comprising a unique identification code and an address code. The status element may transmit a voice message including the data, or may transmit a digital data package including the data. An electronic overview and response dispatch system may be in communication with the status element, wherein the overview and response dispatch system is responsive to the status element to automatically alert and summon responsible personnel when the circuit protectors operate to open one or more of the current paths. The status element may comprise a monitoring module that may be retrofit to a circuit protector. The status element may comprise a speaker, the speaker providing an audio alarm when the circuit path has been interrupted. The status element may be configured for multi-band and multiple mode communication on the cellular communications network.

Still another embodiment of a circuit protector signal transmission system is disclosed herein for a plurality of overcurrent protection fuses. Each of the overcurrent protection fuses has a primary fuse element extending between first and second terminal elements, with the primary fuse elements defining an interruptible current path therethrough upon an occurrence of specified current conditions through the primary fuse element. The signal transmissions system comprises: a status element corresponding to each of the overcurrent protection fuses, the status elements comprising a monitoring modules adapted to sense an operating condition of the respective fuses, and at least one communications module configured to connect with and communicate the operating condition of the fuses over a cellular communications network when opening of the current path in the fuses is sensed; and an electronic overview and response dispatch system in communication with the status elements, wherein the overview and response dispatch system is adapted to alert and summon responsible personnel of one or more operated fuses, and identify the locations of the operated fuses for replacement to efficiently re-energize affected circuitry.

Optionally, the monitoring modules may be mechanically and electrically connected to the first and second terminal elements of the respective fuses at a location exterior to a body of the fuse, thereby providing retrofit installation to an installed fuse. The data signal may comprise a unique identification code, and an address code. The status element may be configured for multi-band communication on the cellular communications network and for multiple mode communication over the cellular communications network. The status elements may transmit a voice message including the operating condition, or a digital data package including the operating condition of the fuses.

While the invention has been described in terms of various specific embodiments, those skilled in the art will recognize that the invention can be practiced with modification within the spirit and scope of the claims.

What is claimed is:

1. A circuit protector signal transmission system for at least one circuit protector defining an interruptible current path therethrough upon an occurrence of specified operating conditions in a circuit, the system comprising:
a status element associated with the circuit protector and adapted to monitor an operating state of the current path; and
a transmitter configured to communicate the operating state of the current path over a cellular communications network.

2. The system of claim 1, wherein the status element transmits a voice message over the cellular communication network, the voice message including operating state information for the circuit protector.

3. The system of claim 1, wherein the status element transmits a data signal over the cellular communication network, the data signal corresponding to the operating condition of the current path, the data signal comprising at least one of unique radio identifier, a manufacturer serial number for the status element, a device type code for the circuit protector, a location or address code for the circuit protector, a power/control code, an equipment identification code, a testing code, a fault code, a customer code, a temperature code, a vibration code, a displacement code, a mechanical stress code, a mechanical strain code, an acoustical emission code, a noise code, a thermal imagery code, an electrical resistance code, a pressure code, a humidity code and a video code.

4. The system of claim 1, wherein the cellular communication network comprises a digital cellular communications network.

5. The system of claim 1, further comprising an electronic overview and response dispatch system in communication with the cellular communications network, wherein the response dispatch system is responsive to communication from the status element to automatically alert and summon responsible personnel when the circuit protector has operated to open the circuit path.

6. The system of claim 5, wherein the electronic overview and response dispatch system is configured to identify the location of the operated circuit protector to the responsible personnel.

7. The system of claim 1, wherein the signal comprises data related to operation of a fuse, the data comprising a unique identification code for the fuse and a location code for the fuse.

8. The system of claim 1, wherein the status element comprises a monitoring module that may be retrofit to a circuit protector.

9. The system of claim 1, wherein the status element comprises a speaker, the speaker providing an audio alarm when the circuit path has been interrupted.

10. The system of claim 1, wherein the status element comprises a microphone for recording a voice message including an identifier for the circuit protector and the location of the circuit protector.

11. The system of claim 1, wherein the status element is configured for multi-band communication on the cellular communications network.

12. The system of claim 1, wherein the status element is configured for multiple mode communication over the cellular communications network.

13. A signal transmission system for a plurality of circuit protectors, each of the circuit protectors defining an interruptible current path therethrough upon an occurrence of specified current conditions through the interruptible current path, the system comprising:
a status element associated with at least one of the circuit protectors, the status element being adapted to monitor an operating state of at least one of the respective current paths, the status element adapted to connect with and communicate over a cellular communications network when one or more of the current paths are interrupted as the circuit protectors operate.

14. The signal transmission system of claim 13, wherein the plurality of circuit protectors are fuses, the status element transmitting data related to operation of the fuses, the data comprising a unique identification code and an address code.

15. The signal transmission system of claim 14, wherein the status element transmits a voice message including the data.

16. The signal transmission system of claim 14, wherein the status element transmits a digital data package including the data.

17. The signal transmission system of claim 13, further comprising an electronic overview and response dispatch system in communication with the status element, wherein the overview and response dispatch system is responsive to the status element to automatically alert and summon responsible personnel when the circuit protectors operate to open one or more of the current paths.

18. The signal transmission system of claim 13, wherein the status element comprises a monitoring module that may be retrofit to a circuit protector.

19. The system of claim 13, wherein the status element comprises a speaker, the speaker providing an audio alarm when the circuit path has been interrupted.

20. The system of claim 13, wherein the status element is configured for multi-band communication on the cellular communications network.

21. The system of claim 13, wherein the status element is configured for multiple mode communication over the cellular communications network.

22. A circuit protector signal transmission system for a plurality of overcurrent protection fuses, each of the overcurrent protection fuses having a primary fuse element extending between first and second terminal elements, the primary fuse elements defining an interruptible current path therethrough upon an occurrence of specified current conditions through the primary fuse element, the signal transmissions system comprising:
a status element corresponding to each of the overcurrent protection fuses, the status elements comprising a monitoring modules adapted to sense an operating condition of the respective fuses, and at least one communications module configured to connect with and communicate the operating condition of the fuses over a cellular communications network when opening of the current path in the fuses is sensed; and
an electronic overview and response dispatch system in communication with the status elements, wherein the overview and response dispatch system is adapted to alert and summon responsible personnel of one or more operated fuses, and identify the locations of the operated fuses for replacement to efficiently re-energize affected circuitry.

23. The system of claim 22, wherein the monitoring modules are mechanically and electrically connected to the first and second terminal elements of the respective fuses at a location exterior to a body of the fuse, thereby providing retrofit installation to an installed fuse.

24. The system of claim 22, wherein the data signal comprises a unique identification code, and an address code.

25. The system of claim 22, wherein the status element is configured for multi-band communication on the cellular communications network.

26. The system of claim 22, wherein the status element is configured for multiple mode communication over the cellular communications network.

27. The system of claim 22, wherein the status elements transmit a voice message including the operating condition.

28. The system of claim 22, wherein the status elements transmit a digital data package including the operating condition of the fuses.
